(19) United States
(12) Patent Application Publication
(10) Pub. No.: US 2019/0009638 A1
(43) Pub. Date: Jan. 10, 2019

(54) Process and Device for Monitoring Air Conditioning System

(71) Applicant: Marco Bonifaccino, Philadelphia, PA (US)

(72) Inventor: Marco Bonifaccino, Philadelphia, PA (US)

(21) Appl. No.: 16/027,433

(22) Filed: Jul. 5, 2018

Related U.S. Application Data
(60) Provisional application No. 62/528,657, filed on Jul. 5, 2017.

(51) Int. Cl. B60H 1/00; F25B 45/00; B60H 1/32

(52) U.S. Cl. CPC B60H 1/00585; B60H 1/00885; F25B 45/00; B60H 2001/3248; F25B 2700/04; F25B 2345/001; B60H 2001/3255; B60H 1/3211

(57) ABSTRACT

A process for monitoring and controlling a refrigerant within an air conditioning system. The process includes, a first sensor measuring air temperature of an output vent of the system, a second sensor measuring an environmental parameter, and at least one pressure sensor measuring an operating pressure of the refrigerant within the system. The process also includes a computer device in signal communication with the first, second, and pressure sensors. The computer device is configured to receive signals indicative of the air temperature, the operating pressure, and environmental parameter from the sensors. The process further includes a pressurized refrigerant reservoir for supplying refrigerant to the system and a flow controller for controlling refrigerant within the system. The flow controller provides fluid communication between the pressurized refrigerant reservoir and the system. The flow controller is in signal communication with the computer device and is configured to receive signals from the computer device.

### CROSS-REFERENCE TO RELATED APPLICATION

This application is based upon and claims priority to U.S. Provisional application No. 62/528,657, filed Jul. 5, 2017, and is being herby incorporated by reference herein. The subject matter of this application is also related to the subject matter of U.S. Provisional Application Ser. No. 62/360,060, filed Jul. 8, 2016, and U.S. patent application Ser. No. 15/475,415, file Mar. 31, 2017, the teachings of both of which are incorporated herein by reference in their entirety.

### FIELD OF THE INVENTION

This disclosure relates to systems for checking and, in some embodiments, recharging air conditioning systems. More particularly, this disclosure relates to systems for checking and, in some embodiments, recharging air conditioning systems including a refrigerant reservoir. The invention relates to a system for monitoring an air conditioning system remotely or locally. More particularly, the invention relates to a method and device for measuring air flow parameters of air conditioning systems and performing a remote or local diagnosis.

### BACKGROUND

Inefficiencies in the quantity of refrigerant (too much or too little) is a major cause of compressor failure in air conditioning systems and can increase the energy cost for operating the air conditioning system, for example, increasing fuel use in a vehicle or electrical use in a structure. Running an air conditioning system on low refrigerant can result in compression failure due to low lubrication levels (delivered with the refrigerant). Running an air conditioning system with too much refrigerant can result in compression failure due to blow out or other issues.

Recharging air conditioning systems, such as motor vehicle air conditioning systems, requires adding or removing refrigerant to or from a low-pressure side and/or a high pressure side of the air conditioning system. Most modern vehicle air conditioning systems are equipped with a thermal expansion valve and a temperature sensor bulb which control the rate of flow of liquid refrigerant into the evaporator (low-pressure side) and which set the maximum operating pressure. When recharging the low-pressure and/or high-pressure sides of a system, care must be taken not to overcharge the system and create potentially damaging or explosive situations.

### SUMMARY

This invention concerns a monitoring system for controlling a refrigerant within an air conditioning system. In one embodiment the monitoring system comprises, a first sensor for measuring air temperature of at least one output vent of the air conditioning system, a second sensor for measuring at least one environmental parameter, and at least one pressure sensor for measuring an operating pressure of the refrigerant within the air conditioning system. In this embodiment the monitoring system may also comprise a computer device in signal communication with the first, second, and pressure sensors. The computer device is configured to receive signals indicative of the air temperature, the operating pressure, and the at least one environmental parameter from the sensors. The embodiment further comprises a pressurized refrigerant reservoir for supplying refrigerant to the air conditioning system and a flow controller for controlling refrigerant within the air conditioning system. The flow controller provides fluid communication between the pressurized refrigerant reservoir and the air conditioning system. The flow controller is in signal communication with the computer device and is configured to receive signals from the computer device.

In a particular embodiment the first sensor is configured to send a first signal indicative of the air temperature of at least one output vent of the air conditioning system to the computer device. The second sensor is configured to send a second signal indicative of at least one environmental parameter to the computer device. The at least one pressure sensor is configured to send a third signal indicative of the operating pressure of the refrigerant to the computer device. The computer device is configured to generate a signal indicative of adding refrigerant to the air conditioning system in response to receiving the first, second, and third signals. The flow controller is configured to add refrigerant upon receipt of the signal indicative of adding refrigerant.

In another example the signal indicative of adding refrigerant is generated when the operating pressure is less than a threshold pressure range. The signal indicative of adding refrigerant is determined by the computer device with reference to a refrigerant performance table stored in the computer device. The refrigerant performance table relates the threshold pressure range to the air temperature of at least one output vent and the environmental parameter. In yet another example the refrigerant performance table is provided in FIG. 6A.

In another example the flow controller is in fluid communication with a low pressure side of the air conditioning system. In another example the operating pressure is measured at the low pressure side of the air conditioning system. In yet another example the operating pressure is measured at a high pressure side of the air conditioning system. In another example the monitoring system further comprises a second pressure sensor for measuring the operating pressure at the high pressure side of the air conditioning system. The operating pressure is measured at both the low pressure and the high pressure side of the air conditioning system.

By way of example the at least one environmental parameter comprises ambient temperature. In another example the at least one environmental parameter comprises ambient humidity.

In another example the monitoring system further comprises a plurality of vent sensors, located in respective output vents of the air conditioning system.

By way of example the computer device is a remote server. In another example the signals are communicated wirelessly.

The invention further comprises a process for controlling refrigerant pressure within an air conditioning system. An example process comprises:

measuring air temperature of at least one output vent of the system;

measuring an operating pressure of a refrigerant within the system;

measuring at least one environmental parameter;

determining, using the air temperature and the environmental parameter, a threshold pressure range of the refrigerant;

comparing the operating pressure with the threshold pressure range of the refrigerant; and

adding refrigerant to the system when the operating pressure is less than the threshold pressure range.

The example method may further comprise:

sending a first signal indicative of the air temperature of the at least one output vent of the system to a computer device;

sending a second signal indicative of the operating pressure of the refrigerant to the computer device;

sending a third signal indicative of the environmental parameter to the computer device;

receiving by the computer device the first, second and third signals;

the computer device using the air temperature and the environmental parameter, to determine a threshold pressure range of the refrigerant;

using the computer device to compare the operating pressure and the threshold pressure range of the refrigerant; and

using the computer device to generate a signal to a flow controller for adding the refrigerant when the operating pressure is below the threshold pressure range.

In another example determining the threshold pressure range comprises using a refrigerant performance table stored in the computer device. The refrigerator performance table relates the threshold pressure range to the air temperature and the environmental parameter. In another example the refrigerator performance table is provided in FIG. 6A.

In another example the flow controller adds refrigerant to a low pressure side of the system. In another example the operating pressure is measured at the low pressure side of the system. In another example the operating pressure is measured at a high pressure side of the system. In yet another example the process further comprises measuring a second operating pressure of the system. The operating pressure is measured at both the low pressure side and the high pressure side of the air conditioning system.

In another example at least one environmental parameter that is measured is ambient temperature. In another example the at least one environmental parameter measured is ambient humidity.

By way of example the signals are communicated wirelessly. In another example the computer device is a remote server.

The invention further comprises a pressure sensor. The pressure sensor comprises a body defining an inlet, and a pressure sensor unit positioned within the body. The pressure sensor unit is in fluid communication with an air conditioning system refrigerant. The pressure sensor unit measures an operating pressure of the air conditioning system refrigerant.

By way of example the inlet comprises a seal configured to provide a fluid tight seal with an access valve of the air conditioning system.

In another example the pressure sensor further comprises a communication module in signal communication with the pressure sensor unit and a computer device. The communication module is configured to transmit the operating pressure of the refrigerant to the computer device.

In another example the pressure sensor is coupled to a low pressure side of the air conditioning system. In yet another example the pressure sensor is coupled to a high pressure side of the air conditioning system.

### BRIEF DESCRIPTION OF THE DRAWING

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a system for monitoring and performing a recharge operation of an air conditioning system including one or more vent sensors, in accordance with some embodiments;

FIG. 2 illustrates a schematic diagram of a vent sensor, in accordance with some embodiments;

FIGS. 3A-3C illustrate a vent sensor configured to couple to an output vent of an air conditioning system, in accordance with some embodiments, FIG. 3A is an isometric view, FIG. 3B is a top view, FIG. 3C is a side view;

FIGS. 4A-4B illustrate a vent sensor configured to couple to an output vent of an air conditioning system, in accordance with some embodiments, FIG. 4A is an isometric view, FIG. 4B is a top view;

FIGS. 5A-5B illustrate a system for monitoring and performing a recharge operation of an air conditioning system in a motor vehicle, in accordance with some embodiments, FIG. 5A illustrates a vent sensor placed within an automobile air conditioning vent, FIG. 5B illustrates a pressure sensor is placed within an automobile air conditioning system;

FIG. 6 illustrates a method of recharging an air conditioning system using the system of FIG. 1, in accordance with some embodiments, FIG. 6A illustrates an example of a temperature and relative humidity performance test table;

FIG. 7 illustrates a schematic diagram of a computing device, in accordance with some embodiments;

FIGS. 8A-8C illustrate a plurality of user interface screens configured to control operation of a vent sensor and/or recharging system, in accordance with some embodiments;

FIG. 9 illustrates a system for monitoring and recharging an air conditioning system including a remote server, in accordance with some embodiments;

FIG. 10 illustrates a system for monitoring and performing a recharge operation of a vehicle air conditioning system having a high-pressure side and a low-pressure side, in accordance with some embodiments;

FIG. 11 illustrates a system for monitoring and performing a recharge operation of a room (or home) air conditioning system having a high-pressure side and a low-pressure side, in accordance with some embodiments;

FIG. 12 illustrates a system for monitoring and performing a recharge operation of an air conditioning system including one or more pressure sensors, in accordance with some embodiments;

FIG. 13 illustrates a schematic diagram of a pressure sensor, in accordance with some embodiments;

FIGS. 14A-14C illustrate a pressure sensor configured to couple to a low-pressure side and/or a high-pressure side of an air conditioning system, in accordance with some embodiments, FIG. 14A is a top view, FIG. 14B is an isometric view, FIG. 14C is a side view;

FIG. 15 illustrates a method of recharging an air conditioning system using the system of FIG. 12, in accordance with some embodiments, FIG. 15B illustrates a method of recharging an air conditioning system using systems illustrated in FIGS. 10-11, in accordance with some embodiments;

FIG. 16 illustrates a system for monitoring and recharging an air conditioning system including a remote server, in accordance with some embodiments;

FIG. 17 illustrates a method of recharging an air conditioning system using a vent sensor and one or more pressure sensors, in accordance with some embodiments;

Note that FIGS. 22 and 24 do not exist;

FIGS. 18A-18B illustrate methods of recharging an air conditioning system using the system of FIGS. 5A, 5B, and 11, in accordance with some embodiments;

FIG. 19A-19B illustrate methods of recharging an air conditioning system using the system of FIG. 10 or FIG. 11, in accordance with some embodiments;

FIG. 20A-20C illustrate example user interface screens configured to control operation of a vent sensor and/or recharging system, in accordance with some embodiments;

FIG. 21 illustrates a system for monitoring and performing a recharge operation of an air conditioning system using the system of FIG. 1 including one or more vent sensors, in accordance with some embodiments;

FIG. 23 illustrates a system for monitoring and performing a recharge operation of an air conditioning system using the system of FIG. 21, in accordance with some embodiments;

FIG. 25 illustrates a system for monitoring an air conditioning system including a vent sensor integrated into the vent chassis, in accordance with some embodiments;

FIG. 26 illustrates a system for monitoring an air conditioning system for preventative maintenance using the system of FIG. 11 including vent and pressure sensors, in accordance with some embodiments;

FIG. 27 illustrates a system for constant monitoring an air conditioning system including at least one vent sensor and at least one pressure sensor, in accordance with some embodiments;

FIG. 28 illustrates a system for monitoring an air conditioning system including vent and pressure sensors, in accordance with some embodiments;

FIG. 29 illustrates a system for monitoring a motor vehicle air conditioning system vent and pressure sensors, in accordance with some embodiments;

FIG. 30 illustrates a system for monitoring a motor vehicle air conditioning system including at least one vent sensor and at least one pressure sensor, in accordance with some embodiments;

FIG. 31 illustrates a system for monitoring a motor vehicle air conditioning system including vent and pressure sensors, in accordance with some embodiments;

FIG. 32 illustrates a system for monitoring many air conditioning systems including a plurality of vent and pressure sensors, in accordance with some embodiments;

FIG. 33 illustrates an isometric view of the embodiment of the vent sensor bottom case, FIG. 33A is a cross sectional view taken at line 33A-33A of FIG. 33;

FIG. 34 illustrates an isometric view of the embodiment of the vent sensor top case, FIG. 34A is a cross sectional view taken at line 34A-34A of FIG. 34;

FIG. 35 illustrates an isometric view of the embodiment of the vent sensor clip mount;

FIG. 36 illustrates an isometric view of the embodiment of the vent sensor pin mount;

FIG. 37 illustrates an isometric view of the embodiment of the vent sensor adhesive mount;

FIG. 38 illustrates an isometric view of the embodiment of the vent sensor with a clip mount;

FIG. 39 illustrates an isometric view of the embodiment of the vent sensor with a pin mount;

FIG. 40 illustrates an isometric view of the embodiment of the vent sensor with an adhesive mount;

FIG. 41a-41c illustrate embodiments of the vent sensor with a clip mount;

FIG. 42a-42b illustrate embodiments of the vent sensor with a clip mount;

FIG. 43a-43b illustrate embodiments of the vent sensor with a clip mount;

FIG. 44a-44b illustrate embodiments of the vent sensor with an adhesive mount; and

FIG. 45a-45b illustrate embodiments of the vent sensor with a pin mount.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected,” refer to a relationship wherein structures are secured or attached to one another either directly or indirectly through intervening structures, as well as both movable or rigid attachments or relationships, unless expressly described otherwise.

In various embodiments, a system for monitoring an air conditioning system and/or performing a recharge operation of the air conditioning system is disclosed. The system includes one or more vent sensors configured to couple to one or more outlet vents of the air conditioning system. The one or more vent sensors are configured to receive air flow output from the air conditioning system and measure one or more parameters of the air flow. For example, in some embodiments, a vent sensor is configured to measure temperature of the air flow. The system further includes a computing device configured to receive a signal indicative of the one or more parameters of the air flow measured by one or more vent sensors. In some embodiments, the computing device could be configured to receive data from the Internet, for example, the ambient environmental parameters around the air conditioning system. In some embodiments, the computing device is configured to calculate and/or monitor the operating parameters (e.g., air flow temperature and/or humidity) and can be further configured to determine if the air conditioning system is working at a satisfactory efficiency. In some embodiments, the computing device is configured to calculate and monitor the operating parameters of the air conditioning system based on the one or more measured air flow parameters and can be further configured to adjust the refrigerant charge level of the air conditioning system in order to maintain a satisfactory efficiency. Although running an air conditioning system with a low level of efficiency will affect the operating parameters, monitoring the operating parameters can also detect other problems in the air conditioning system even when the refrigerant charge is correct, such as sensor problems, dirty air filters, a faulty thermostat, a faulty compressor, etc.

In some embodiments, the system includes a flow controller coupled to a charging reservoir. The flow controller is configured to couple to a refrigerant reservoir of the air conditioning system. The flow controller is in signal communication with the computing device. The computing device controls the flow controller to adjust the refrigerant level of the air conditioning system. The computing device controls operation of the flow controller based on the one or more parameters of the air flow output measured by one or more vent sensors and/or one or more parameters of fluid flow measured by one or more pressure sensors to increase and/or decrease the refrigerant charge level of the air conditioning system to an acceptable level.

In various embodiments, a system for monitoring an air conditioning system and/or performing a recharge operation of the air conditioning system is disclosed. The system includes at least one pressure sensor configured to couple to a high-pressure side and/or a low pressure side of the air conditioning system. The at least one pressure sensor is configured to receive refrigerant fluid flow from the air conditioning system and measure the pressure of the fluid flow. For example, in some embodiments, the pressure sensor is configured to measure the pressure level of a high-pressure and/or a low-pressure side of the air conditioning system. The system further includes a computing device configured to receive a signal indicative of the measured pressures. In some embodiments, the computing device is configured to calculate and monitor the operating parameters of the air conditioning system based on the one or more measured pressure parameters and can be further configured to adjust the refrigerant charge level of the air conditioning system in order to maintain a satisfactory efficiency. In some embodiments, the computing device could be configured to receive data from the Internet, for example, the ambient environmental parameters around the air conditioning system.

In various embodiments, a system for monitoring an air conditioning system and/or performing a recharge operation of the air conditioning system is disclosed. The system includes one or more vent sensors configured to couple to one or more outlet vents of the air conditioning system and at least one pressure sensor configured to couple to a high-pressure side and/or a low-pressure side of the air conditioning system. The one or more vent sensors are configured to receive air flow output from the air conditioning system and measure one or more parameters of the air flow. For example, in some embodiments, the vent sensor is configured to measure temperature of the air flow. The at least one pressure sensor is configured to receive refrigerant fluid flow from the air conditioning system and measure the pressure of the fluid flow. For example, in some embodiments, the pressure sensor is configured to measure the pressure level of a high-pressure and/or a low-pressure side of the air conditioning system. The system further includes a computing device configured to receive a signal indicative of the one or more parameters measured by one or more vent sensors and the at least one pressure sensor. In some embodiments, the computing device could be configured to receive and/or transmit data from the Internet, for example, the ambient environmental parameters around the air conditioning system. In some embodiments, the computing device is configured to calculate and monitor the operating parameters of the air conditioning system based on the one or more measured parameters and can be further configured to adjust the refrigerant charge level of air conditioning system in order to maintain a satisfactory efficiency. Although running an air conditioning system with a low level of efficiency will affect the operating parameters, monitoring the operating parameters can also detect other problems in the air conditioning system even when the refrigerant charge is correct, such as sensor problems, dirty air filters, a faulty thermostat, a faulty compressor, etc.

In various embodiments, a system for monitoring an air conditioning system and/or performing a recharge operation of the air conditioning system is disclosed. The system includes one or more vent sensors configured to couple to one or more outlet vents of the air conditioning system. The one or more vent sensors are configured to receive air flow output from the air conditioning system and measure one or more parameters of the air flow. For example, in some embodiments, the vent sensor is configured to measure temperature of the air flow. The system further includes a wireless internet router or a gateway, for example, an IoT gateway, configured to receive a signal indicative of the one or more parameters of the air flow measured by the one or more vent sensors and send the signal to a monitoring data center, which, depending on the implementation, may be locally or remotely located. In some embodiments, the monitoring data center is configured to calculate and/or monitor the operating parameters (e.g., air flow temperature and/or humidity) of the air conditioning system and can be further configured to determine if the air conditioning system is working at a satisfactory efficiency. In some embodiments, the monitoring data center is configured to calculate and monitor the operating parameters of air conditioning system based on the one or more measured air flow parameters and can be further configured to adjust the refrigerant charge level of air conditioning system in order to maintain a satisfactory efficiency. Although running an air conditioning system with a low level of efficiency will affect the operating parameters, monitoring the operating parameters can also detect other problems in the air conditioning system even when the refrigerant charge is correct, such as sensor problems, dirty air filters, a faulty thermostat, a faulty compressor, etc. In some embodiments, the monitoring data center is configured to send a message/warning to a mobile device as a text message, or as an email, or directly to social media, etc.

In some embodiments, the system includes a flow controller coupled to a charging reservoir. The flow controller is configured to couple to a refrigerant reservoir of the air conditioning system. The flow controller is in signal communication with the monitoring data center through a wireless internet router or a gateway, for example, an IoT gateway. The monitoring data center controls the flow controller to adjust the refrigerant level of the air conditioning system. The monitoring data center controls operation of the flow controller based on the one or more parameters of the air flow output measured by one or more vent sensors and/or one or more parameters of fluid flow measured by one or more pressure sensors to increase and/or decrease the refrigerant charge level of the air conditioning system to an acceptable level.

In various embodiments, a system for monitoring an air conditioning system and/or performing a recharge operation of the air conditioning system is disclosed. The system includes at least one pressure sensor configured to couple to a high-pressure side and/or a lowpressure side of the air conditioning system. The at least one pressure sensor is configured to receive refrigerant fluid flow from the air conditioning system and measure the pressure of the fluid flow. For example, in some embodiments, the pressure sensor is configured to measure the pressure level of a high-pressure and/or a low-pressure side of the air conditioning system. The system further includes a monitoring data center configured to receive a signal indicative of the measured pressures through a wireless internet router or a gateway, for example, an IoT gateway. In some embodiments, the monitoring data center is configured to calculate and monitor the operating parameters of the air conditioning system based on the one or more measured pressure parameters and can be further configured to adjust the refrigerant charge level of the air conditioning system in order to maintain a satisfactory efficiency. In some embodiments, the monitoring data center is configured to send a message/warning to a mobile device as a text message, or as an email, or directly to social media, etc.

In various embodiments, a system for monitoring an air conditioning system and/or performing a recharge operation of the air conditioning system is disclosed. The system includes one or more vent sensors configured to couple to one or more outlet vents of the air conditioning system and at least one pressure sensor configured to couple to a high-pressure side and/or a low-pressure side of the air conditioning system. The one or more vent sensors are configured to receive air flow output from the air conditioning system and measure one or more parameters of the air flow. For example, in some embodiments, the vent sensor is configured to measure temperature of the air flow. The at least one pressure sensor is configured to receive refrigerant fluid flow from the air conditioning system and measure the pressure of the fluid flow. For example, in some embodiments, the pressure sensor is configured to measure the pressure level of a high-pressure and/or a low-pressure side of the air conditioning system. The system further includes a wireless internet router or a gateway, for example, an IoT gateway, configured to receive a signal indicative of the one or more parameters of the air flow measured by one or more vent sensors and the at least one pressure sensor, and in communication with a monitoring data center. In some embodiments, the computing device is configured to calculate and monitor the operating parameters of the air conditioning system based on the one or more measured parameters and can be further configured to adjust the refrigerant charge level of the air conditioning system in order to maintain a satisfactory efficiency. In some embodiments, the monitoring data center is configured to send a message/warning to a mobile device as a text message, or as an email, or directly to social media, etc.

In some embodiments, the system for monitoring an air conditioning system and/or performing a recharge operation of the air conditioning system could be used for monitoring and/or performing a recharge operation of different system, such as, for example, HVAC system, or a water heating system.

In some embodiments, the computing device can be a cell phone, an AC service computer, a tablet, a laptop, a remotely located monitoring data center, a home thermostat, a car's computer, etc. In some embodiments, the gateway can be the home thermostat, a car's computer, a router WiFi, etc.

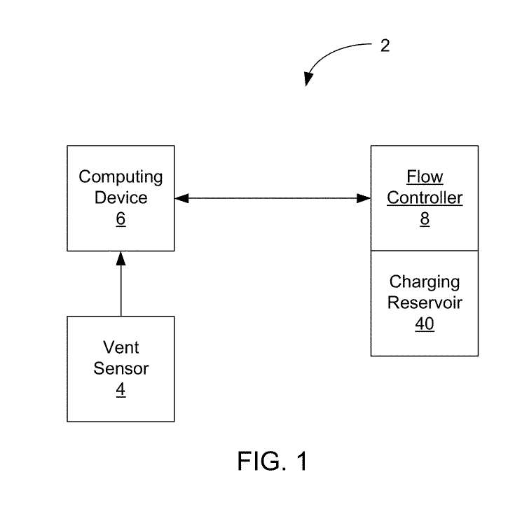

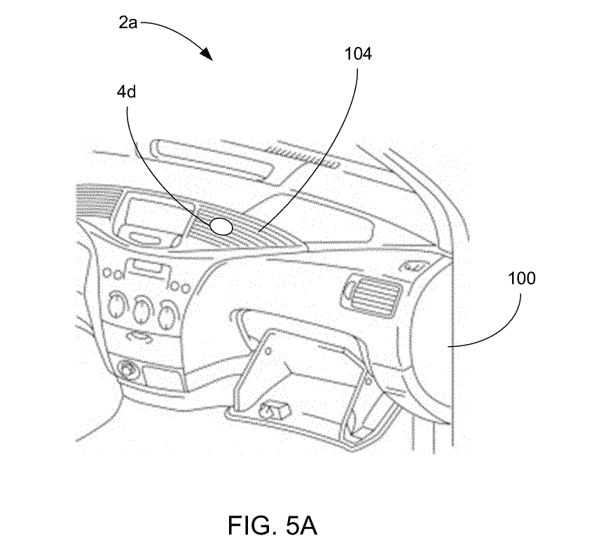

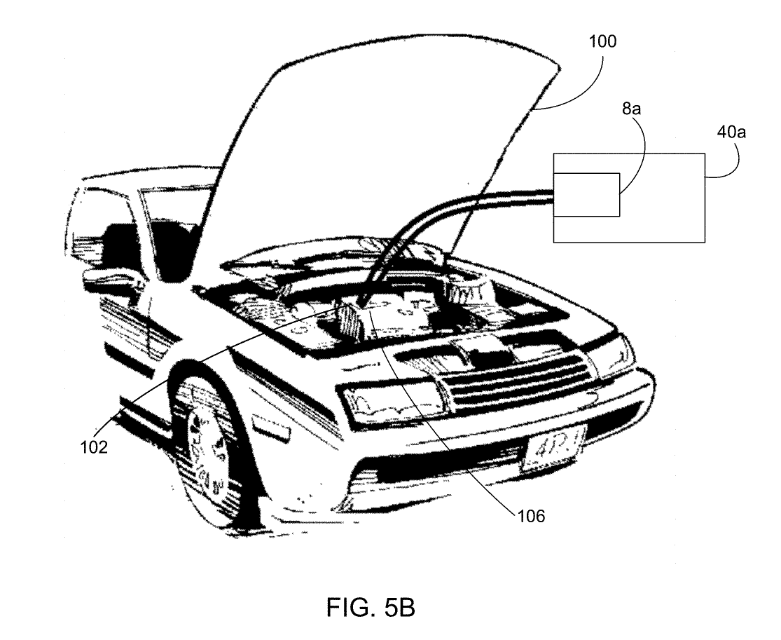

FIG. 1 illustrates one embodiment of a system 2 for monitoring and recharging an air conditioning system, in accordance with some embodiments. The system 2 includes at least one vent sensor 4 and a computing device 6. The vent sensor 4 is configured to be coupled to the front or back side of an output vent or be positioned inside the duct, of the air conditioning system. (See, for example, FIG. 5A.) The vent sensor 4 includes at least one intake configured to receive a portion of the air flow from the output vent. The vent sensor 4 receives the air flow and measures one or more parameters of the air flow. Measured parameters of the air flow can include, but are not limited to, temperature, pressure, humidity, etc.

In some embodiments, the vent sensor 4 is in signal communication with the computing device 6. For example, in some embodiments, the vent sensor 4 includes at least one circuit configured to transmit a signal indicative of the one or more measured parameters to the computing device 6. The vent sensor 4 can use any suitable communication protocol and/or medium, such as Bluetooth, WiFi, Near-Field Communication (NFC), TCP/IP, Ethernet, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, etc., to transmit the signal to the computing device 6, as discussed in more detail below. The computing device 6 is configured to receive the signal from one or more vent sensor 4 and perform one or more operations. It will be appreciated that the computing device 6 can include a processor and/or other circuit coupled to, embedded in, and/or remote from the vent sensor 4.

In some embodiments, the computing device 6 is configured to calculate and/or monitoring the operating parameters (e.g., air flow temperature and/or humidity) of the air conditioning system based on the received one or more measured parameters. For example, in some embodiments, the computing device 6 is configured to determine if the air conditioning system is working at a satisfactory efficiency based on the received one or more measured parameters. For example, in some embodiments, the one or more measured parameters include temperature of the output air flow. In such embodiments, the computing device 6 is configured to calculate the current level of efficiency of the air conditioning system based on the temperature of the air flow. The computing device 6 can be configured to determine whether the efficiency of the air conditioning system is too low, too high, or at an acceptable level based on the measured parameters of the air flow. The computing device 6 may be configured to receive additional information to determine the charge status of the air conditioning system, such as information regarding ambient environmental conditions such as the temperature and/or humidity outside of the air conditioner space (e.g., the vehicle for or the building).

In some embodiments, the vent sensor 4 is configured to provide ambient environmental information to the computing device 6 prior to and/or after being coupled to the output air vent. For example, in some embodiments, the vent sensor 4 can be configured to measure and transmit parameters of the ambient environment around the air conditioning system, such as ambient temperature, ambient humidity, etc. to the computing device 6. In some embodiments, the vent sensor 4 includes a first sensor for measuring output air flow parameters and a second sensor for measuring ambient environmental information, although it will be appreciated that additional sensor can be included in the vent sensor 4.

In some embodiments, the computing device 6 is configured to calculate the optimal and/or desired operating parameters of the air conditioning unit and/or the current operating parameters. After determining the difference between the optimal operating parameters and the current operating parameters, the computing device 6 can be configured add and/or remove refrigerant to and/or from the air conditioning unit to reach an acceptable level in order to maintain a satisfactory efficiency. If the operating parameter is the air flow temperature, and the computing device 6 determines that the air flow temperature is too high, then the computing device 6 determines that refrigerant needs to be added to the air conditioning unit, and vice versa if the air flow temperature is too low. If the operating parameter is either the low- or high-pressure side pressure and the computing device 6 determines that the pressure is below the optimal pressure, then the computing device 6 determines that refrigerant needs to be add to the air conditioning unit, and vice versa if the pressure is too high. In some embodiments, the computing device 6 generates at least one of an audible, tactile, visual, electronic, and/or other some other indication to a user to indicate an increase and/or a decrease in the charge of the air conditioning system. In some embodiments, the computing device 6 operates a flow controller 8 in response to the calculated operating parameters.

In some embodiments, the system 2 includes a flow controller 8. The flow controller 8 is configured couple to a charging reservoir 40 and to further couple to a refrigerant reservoir (see FIG. 5B) of the air conditioning unit. The flow controller is configured to control a flow rate of refrigerant from the charging reservoir 40 to the refrigerant reservoir. In some embodiments, the computing device 6 is in signal communication with the flow controller 8. The flow controller 8 can use any suitable communication protocol and/or medium, such as Bluetooth, WiFi, Near-Field Communication (NFC), TCP/IP, Ethernet, IEEE 802.15.4 (LRPANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, etc., to transmit the signal to the computing device 6, as discussed in more detail below. The computing device 6 can transmit one or more control signals to the flow controller 8 to increase and/or decrease the amount of refrigerant in the refrigerant reservoir. The flow controller 8 can include a one-way flow (refrigerant flowing from the charging reservoir 40 to the refrigerant reservoir) and/or a two-way flow (refrigerant flowing in either direction).

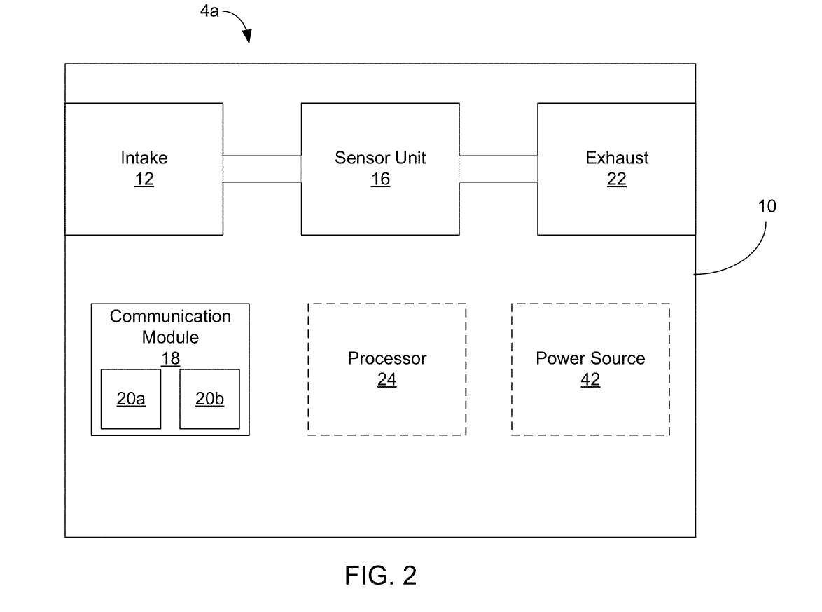

FIG. 2 illustrates a schematic diagram of a vent sensor 4a, in accordance with some embodiments. The vent sensor 4a is similar to the vent sensor 4 discussed above, and similar description is not repeated herein. The vent sensor 4a is configured to be coupled to the front or back side of an output air vent of an air conditioning system or be positioned inside a duct of the system. The vent sensor 4a receives air flow from the output vent through an intake 12 formed in a body 10 of the vent sensor 4a. The intake 12 is in fluid communication with at least one sensor unit 16. The sensor unit 16 includes one more circuits configured to measure at least one parameter of the air flow input, such as temperature, humidity, etc. provided through the intake 12. In some embodiments, the vent sensor 4a can include a plurality of sensor units 16 each configured to measure one or more parameters of the air flow.

The sensor unit 16 is electrically coupled to a communication module 18. The communication module 18 is configured to receive a signal indicative of the one or more measured parameters of the air flow input and transmit the signal to a remote device, such as the computing device 6 and/or a monitoring data center. The communication module 18 can include a wired communication module 20a and/or a wireless communication module 20b. For example, in some embodiments, the communication module 18 can include a wired communication module 20a using one or more wired communication protocols, such as TCP/IP, UDP, Serial, Parallel, and/or any other suitable wired communication, as discussed in more detail below. As another example, in some embodiments, the communication module 18 can include a wireless communication module 20b using one or more wireless communication protocols, such as Bluetooth, NFC, RFID, WiFi, 802.11a/b/c/g, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, and/or any other suitable wireless communication protocol, as discussed in more detail below.

In some embodiments, the vent sensor 4a includes an exhaust 22 formed in the body to allow the air flow to be evacuated from the vent sensor 4a. The exhaust 22 is in fluid communication with the sensor unit 16. In some embodiments, the intake 12 and the exhaust 22 are positioned in-line, although it will be appreciated that the intake 12 and the exhaust 22 can be positioned at an off-set and/or at an angle with respect to each other. Although embodiments are illustrated herein including an intake 12, a sensor unit 16, a communication module 18, and an exhaust 22, it will be appreciated that the vent sensor 4a can include fewer, additional, and/or alternative elements to those illustrated herein and are within the scope of this disclosure, such as, for example, a power source 42, a processor 24, and/or any other suitable circuit or physical elements. In some embodiments, the exhaust 22 can be omitted and the intake 12 can serve as an intake/exhaust to allow air flow in and out of the body 10. In some embodiments, the power source 42 can be a solar power source.

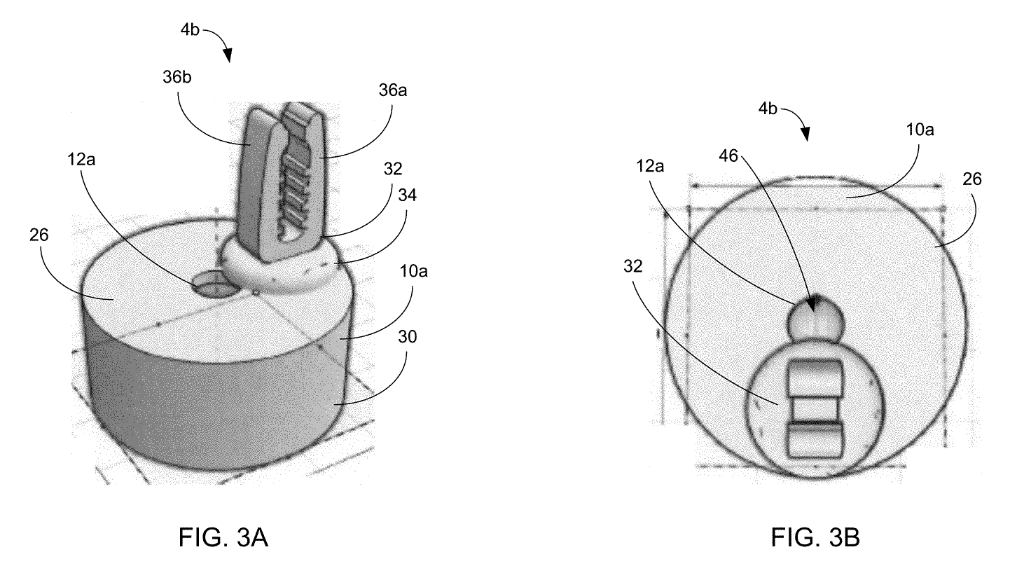

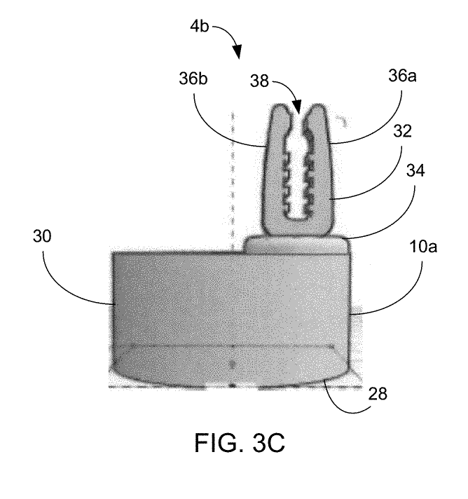

FIGS. 3A-3C illustrate a vent sensor 4b, in accordance with some embodiments. The vent sensor 4b is similar to the vent sensor 4 discussed above, and similar description is not repeated herein. The vent sensor 4b includes a cylindrical body 10a. The cylindrical body 10a includes an intake face 26, a rear face 28, and a sidewall 30 extending therebetween. In the illustrated embodiment, the intake face 26 and the rear face 28 have similar diameters, although it will be appreciated that the intake face 26 can have a greater and/or lesser diameter than the rear face 28.

The intake face 26 defines an intake 12a . The intake 12a includes a circular opening extending through the intake face 26 to an internal volume 46 of the vent sensor 4b. The intake 12a can be positioned in any suitable location on the intake face 26. For example, in the illustrated embodiment, the intake 12a is centered on the intake face 26, although it will be appreciated that the intake 12a can be offset from the center of the intake face 26 and is within the scope of this disclosure. In the illustrated embodiment, the intake 12a functions as an intake/exhaust and allows air flow into and out of the body 10a of the vent sensor 4b. In other embodiments, an exhaust face 28 can define an exhaust.

In some embodiments, an attachment mechanism 32 is coupled to the intake face 26. The attachment mechanism 32 is sized and configured to couple the vent sensor 4b to an output air vent of an air conditioning system. In the illustrated embodiment, the attachment mechanism 32 is a clip. The clip includes a base 34 and a pair of prongs 36a, 36b extending from the base 34. The prongs 36a, 36b define a channel 38 therebetween sized and configured to receive a portion of an output air vent of an air conditioning system therein such that the vent sensor 4b is retained on the output air vent. Although a clip is illustrated, it will be appreciated that any suitable attachment mechanism 32 can be used to couple the body 10a to the output air vent. For example, the attachment mechanism 32 can include any suitable adhesive, mechanical coupling (clip, press-fit, etc.), and/or any other suitable attachment mechanism 32.

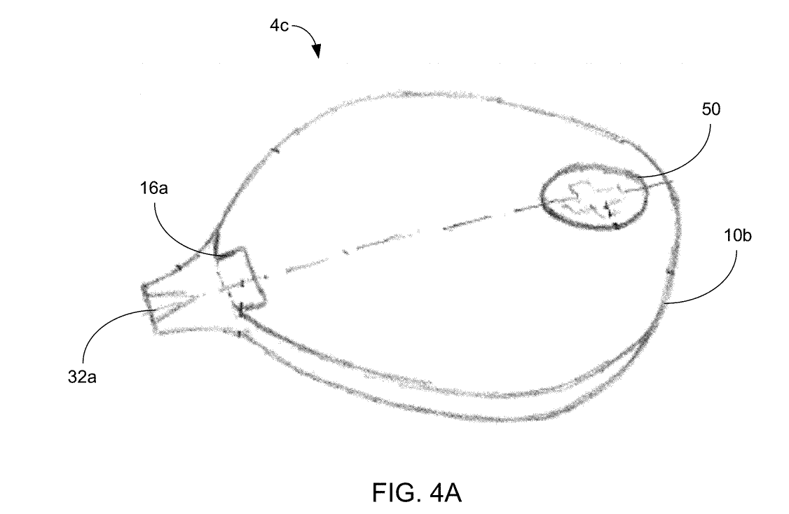

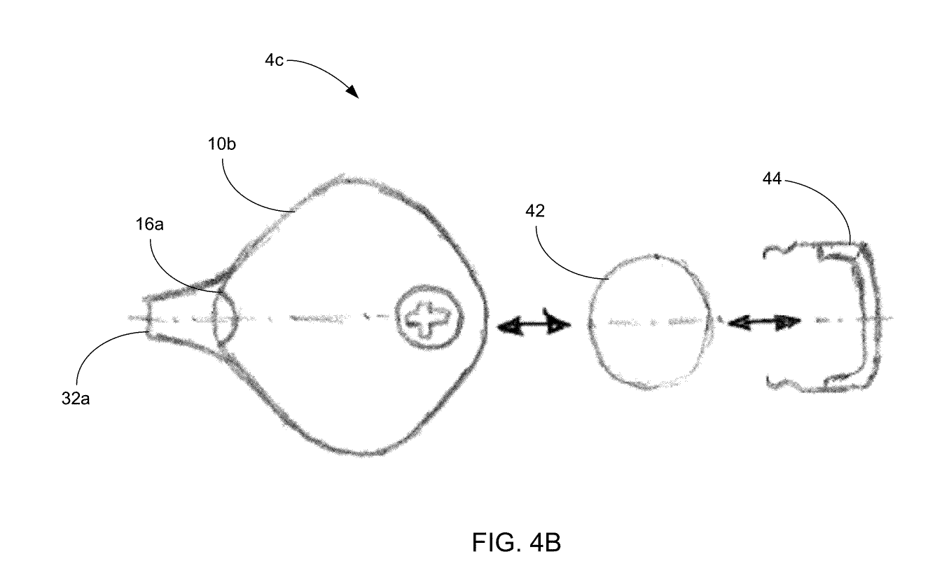

FIGS. 4A-4B illustrate an embodiment of a vent sensor 4c , in accordance with some embodiments. The vent sensor 4c includes a body 10b defining a generally clam-shell shape. A sensor unit 16a is coupled to an outer surface of the body 10b. The sensor unit 16a is positioned in-line with an attachment mechanism 32a such that when the vent sensor 4c is coupled to an output vent of an air conditioning system, the sensor unit 16a is positioned in-line with the air flow from the output vent. In some embodiments, the vent sensor 4c is configured to receive a battery 42 within a recess defined by the body 10b. A battery retention clip 44 is configured to be inserted into the recess to maintain the battery in a fixed position.

FIGS. 5A-5B illustrate an embodiment of a system 2a configured to recharge an air conditioning system 102 of a motor vehicle 100. The system 2a includes a vent sensor 4d coupled to an output vent 104 of the air conditioning system 102. The vent sensor 4d can include any suitable vent sensor and/or features of a vent sensor discussed herein. The vent sensor 4d is configured to receive an air flow output from the output vent 104 through an intake 12 (see FIGS. 3A-3E). A sensor unit 16 in the vent sensor 4d is configured to measure one or more parameters of the air flow output and transmit the one or more parameters to a computing device, such as computing device 6.

The system 2a includes a charging reservoir 40a. The charging reservoir 40a is configured to recharge a refrigerant reservoir 106 of the air conditioning system 102. In some embodiments, the charging reservoir 40a recharges the refrigerant reservoir 106 based on the one or more measured parameters of the air flow output. For example, in some embodiments, the vent sensor 4d is configured to provide at least one measured parameter of the air flow output to a computing device 6. The computing device 6 calculates the current charge state of the refrigerant reservoir 106 based on the at least one measured parameter and indicates whether additional charging from the charging reservoir 40a is required.

In some embodiments, a flow controller 8a is coupled to the charging reservoir 40a to control refrigerant flow from the charging reservoir 40a to the air conditioning system 102. The flow controller 8a can be configured to receive a signal from the computing device 6 for controlling a flow rate from the charging reservoir 40a to the air conditioning system 102. For example, in some embodiments, the computing device 6 is configured to determine the current charge state of the refrigerant reservoir 106 and determine whether refrigerant should be added to and/or removed from the refrigerant reservoir 106. If refrigerant is to be added, then the computing device 6 transmits a signal to the flow controller 8a to transfer refrigerant from the charging reservoir 40a to the refrigerant reservoir 106. If refrigerant is to be removed, then the computing device 6 transmits a signal to the flow controller 8a to transfer refrigerant from the refrigerant reservoir 106 to the charging reservoir 40a and/or to the separate discharge reservoir (now shown). In other embodiments, the flow controller 8a can be controlled by one or more alternative methods.

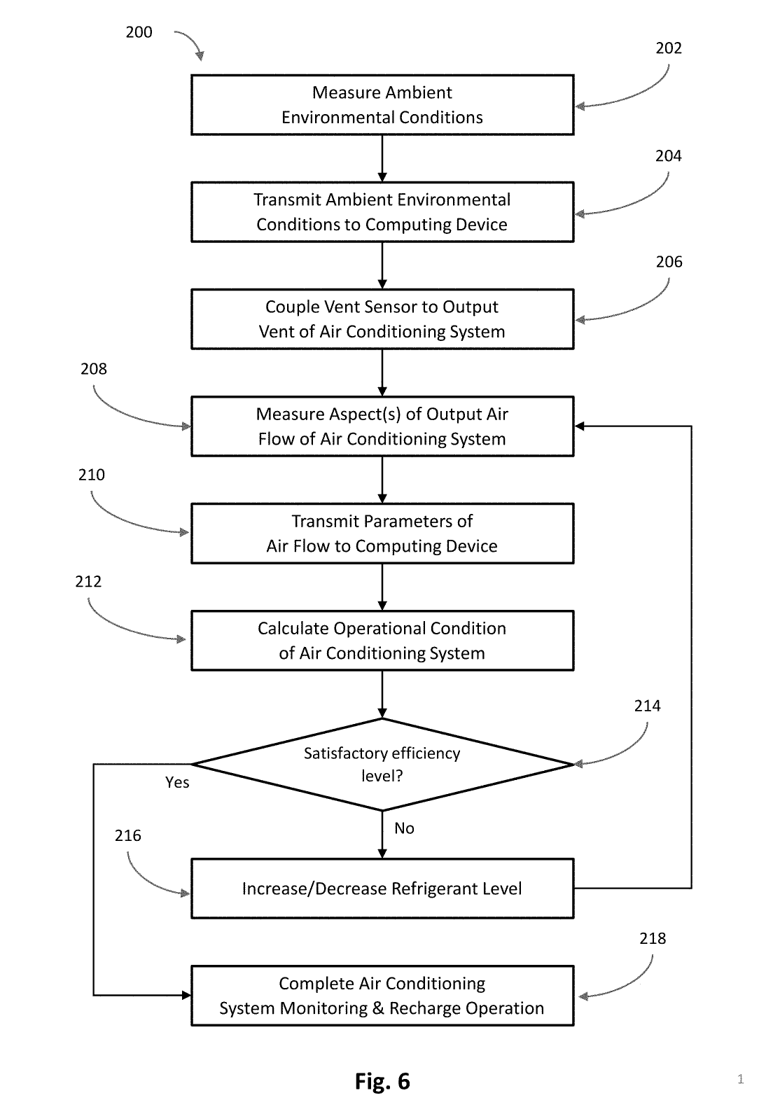

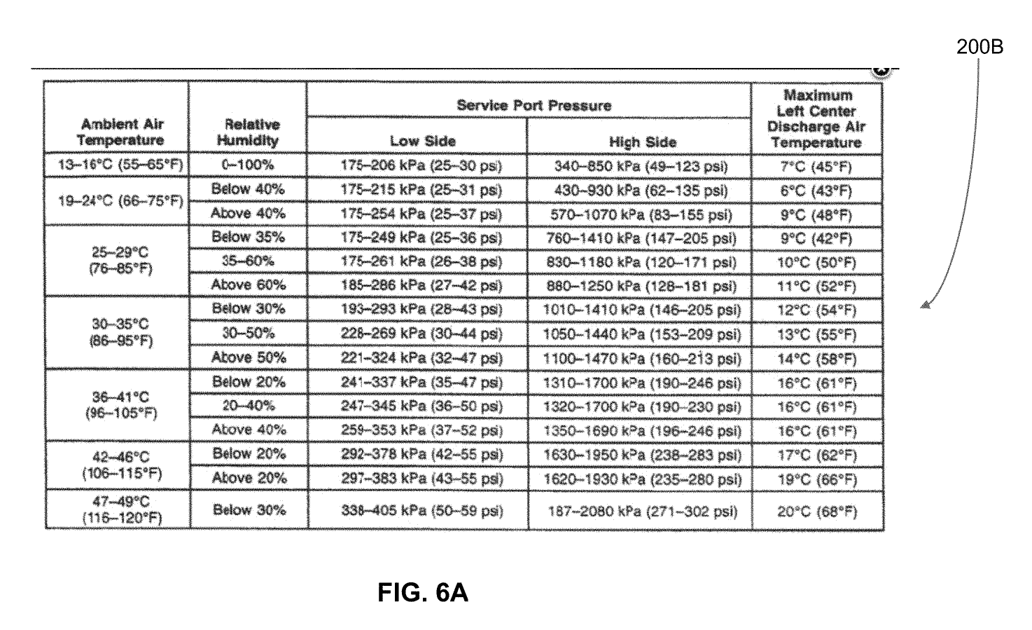

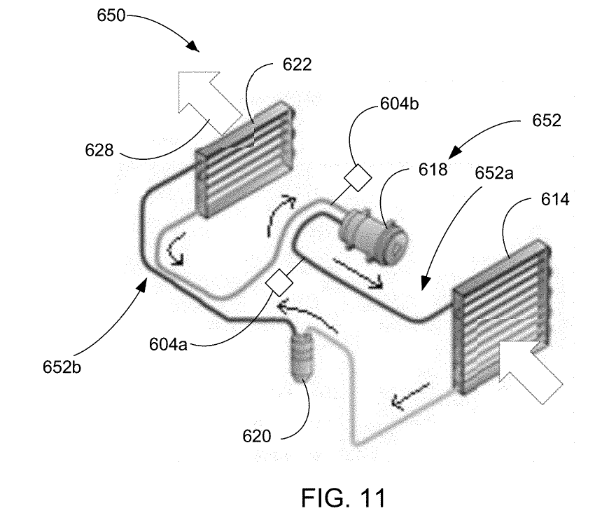

FIG. 6 illustrates a method 200 of recharging an air conditioning system, such as the air conditioning system 102 illustrated in FIGS. 5A-5B and/or the room (or home) air conditioning 652 illustrated in FIG. 11 and described in detail below, using a monitoring and recharge system, such as the systems 2-2a discussed above, in accordance with some embodiments. At step 202, one or more ambient environmental conditions, such as ambient temperature and/or ambient humidity are measured. The ambient environmental conditions can be measured using a sensor integrally formed in the vent sensor 4 and/or using any other sensor module. For example, in some embodiments, the ambient environmental conditions can be measured using the sensor unit 16, a separate ambient condition sensor module formed integrally and/or coupled to the vent sensor 4, and/or a separate sensor module.

At step 204, the ambient environmental conditions are provided to the computing device 6. The ambient environmental conditions can be provided using any suitable communications system, such as, for example a wireless communication module 20a and/or wired communication module 20b. The ambient environmental conditions can be transmitted using any suitable protocol over any suitable medium, as discussed herein.

At step 206, the vent sensor 4 is coupled to an output air vent 104 of the air conditioning system to be monitored and/or recharged, such as air conditioning system 610, 652. The vent sensor 4 can be coupled to the output air vent 104 using any suitable attachment mechanism, such as, for example, a mechanical attachment (such as a clip, pin, etc.), an adhesive attachment, and/or any other suitable attachment. The vent sensor 4 is coupled to the output air vent 104 such that air flow from the output vent 104 is directed towards and/or into an inlet 12 formed in the vent sensor 4.

At step 208, the vent sensor 4 measures one or more parameters of an air flow output of the air conditioning system 610, 652. The vent sensor 4 can measure the temperature, humidity, and/or additional or alternative parameters of the air flow output. The one or more parameters of the air flow output are measured by a sensor unit 16 formed integrally with the vent sensor 4. The sensor unit 16 includes one or more sensors configured to measure the one or more parameters of the air flow output.

At step 210, the one or more measured parameters of the air flow output are provided to the computing device 6. The measured parameters can be provided using any suitable communications system, such as, for example a wireless communication module 20a and/or wired communication module 20b. The measured parameters can be transmitted using any suitable protocol over any suitable medium, as discussed herein.

At step 212, the computing device 6 determines the current operational state of the air conditioning system 610, 652, such as the operating parameters of the air conditioning system 610, 652 and determines, at step 214, whether the air conditioning system 610, 652 is working at a satisfactory efficiency. The computing device 6 can utilize one or more algorithms, parameters and/or other functions to determine if the air conditioning system is working at a satisfactory efficiency. For example, in some embodiments, a correlation between the ambient humidity, the ambient temperature around the air conditioning system 610, 652, expressed with a temperature and relative humidity performance test table, can be used to determine the optimal air flow output temperature of the air conditioning system 610, 652, although it will be appreciated that additional and/or alternative ambient and/or measured parameters can be used to determine the optimal air flow output temperature of the air conditioning system 610, 652. A temperature and relative humidity performance test table is a table used to determine air conditioner unit performance according to ambient environmental condition around the air conditioner. Measurements of the ambient environmental conditions, such as temperature and humidity, are used to determine the optimal operating parameters of an air conditioner unit, such as, for example, the operating temperature and/or the operating pressure. The temperature and relative humidity performance test table maps each of a number of different combinations of ambient temperature and humidity to a corresponding, for example, desired air flow temperature. FIG. 6A illustrates an example of a temperature and relative humidity performance test table. Based on the table in FIG. 6A, an example of the air conditioning system satisfactory efficiency can be based on determining a threshold pressure range of a low or high side of the air conditioning system with reference to measured vent temperature and environmental parameters such as temperature and humidity. The threshold pressure range is compared to the measured operating pressure at the low or high side of the air conditioning system. If the operating pressure is within the threshold pressure range, the system can be considered working at a satisfactory efficiency. If, for example, a measured pressure at the low pressure side of the air condition system is below the threshold pressure range, the system can be considered not to be working at a satisfactory efficiency, then refrigerant may need to be added to the air conditioning system.

For example, in some embodiments, an ambient temperature in a range of about 80-85° F. can be measured by the vent sensor 4 at step 202. At step 210, a temperature of the air flow output of the air conditioning system is measured and compared to one or more additional ambient environmental parameters to determine if the air flow temperature falls outside of a predetermined acceptable range, such as, for example, 35-45° F. If the measured air flow output temperature is above 45° F., then the computing device 6 determines that the air conditioning system 610, 652 is not working at a satisfactory efficiency level. Similarly, if the measured air flow output temperature is above 35° F. but below 45° F., then the computing device 6 determines that the air conditioning system 610, 652 is working at a satisfactory efficiency level. As another example, in some embodiments, an ambient humidity of about 90% can be measured by the vent sensor 4 at step 202. At step 210, a humidity of the air flow output of the air conditioning system 610, 652 is measured and compared to one or more additional ambient environmental parameters to determine if the air flow humidity falls outside of a predetermined acceptable humidity range, such as 15-25%. If the measured air flow humidity is above 25%, then the computing device 6 determines that the air conditioning system 610, 652 is not working at a satisfactory efficiency level. Similarly, if the measured air flow humidity is above 15% but below 25%, then the computing device 6 determines that the air conditioning system 610, 652 is working at a satisfactory efficiency level. The ranges and/or ambient conditions discussed herein are provided only as examples, and it will be appreciated that the computing device 6 can determine an acceptable range based on any applicable ambient environmental conditions and/or air flow parameters.

If the computing device 6 determines that the satisfactory efficiency level is not at an acceptable level and that refrigerant should be added to or removed from the air conditioning system 610, 652, then the method 200 proceeds to step 216. If the computing device 6 determines the system efficiency is at an acceptable level, then the method 200 proceeds to step 218. At step 216, refrigerant is added to and/or removed from the air conditioning system 610, 652. A flow controller 8 can be operated to add and/or remove the refrigerant in order to restore a satisfactory efficiency. In some embodiments, the flow controller 8 is controlled by the computing device 6. For example, in some embodiments, the computing device 6 generates a signal based on the calculated current level of efficiency of the air conditioning system 610, 652. If the current level of efficiency is determined to be low, then the flow controller 8 is operated to add or remove refrigerant to the air conditioning system 610, 652.

Continuing one of the examples from above, if the measured air flow output temperature is above 45° F. (e.g., above the predetermined acceptable temperature range), then the computing device 6 activates the flow controller 8 to add and/or remove refrigerant to and/or from the refrigerant reservoir 106 of the air conditioning system 610, 652. It will be appreciated by those skilled in the art that different behaviors for different acceptable ranges and/or nonacceptable measurements are within the scope of this disclosure.

The method 200 repeats steps 208-216 as necessary to obtain a satisfactory efficiency level of the air conditioning system 610, 652. The method 200 can repeat the steps of measuring one or more parameters of the output flow, characterizing the efficiency level, and adjusting the refrigerant level as needed. When the computing device 6 determines that an acceptable efficiency level has been reached, the method 200 proceeds to step 218. At step 218, the recharge operation is completed. In some embodiments, the computing device 6 can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the computing device 6 can be provided to a remote server for storage, comparison, collation, and/or any other suitable use.

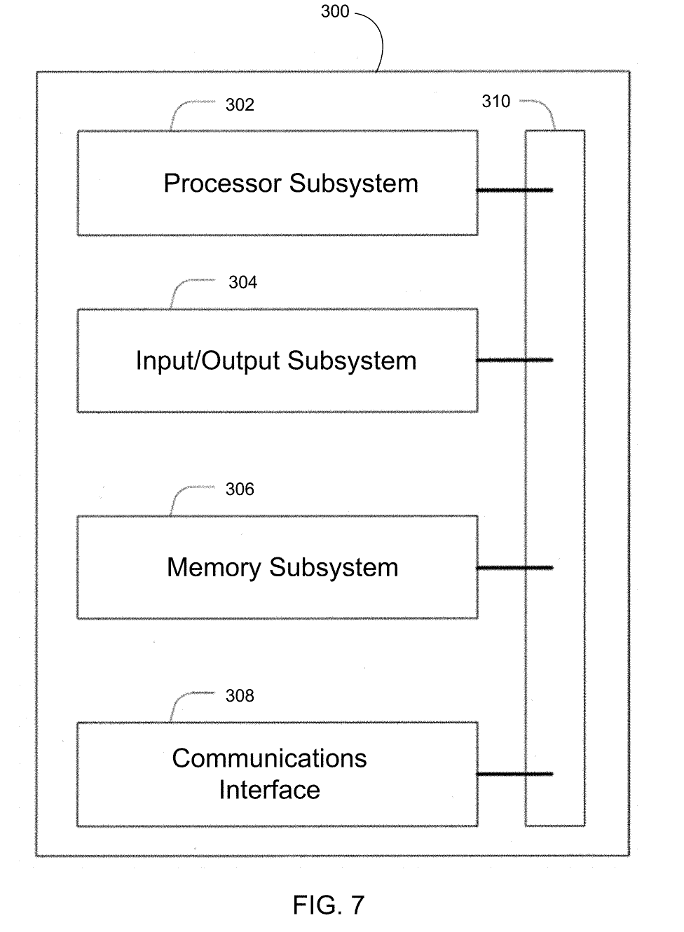

FIG. 7 is a schematic view of an illustrative electronic device 300 capable of implementing the system and method of customization third-party devices using a smart device. The electronic device 300 is a representative device that be a representative embodiment of the computing device 6. The electronic device 300 may comprise a processor subsystem 302, an input/output subsystem 304, a memory subsystem 306, a communications interface 308, and a system bus 310. In some embodiments, one or more than one of the electronic device 300 components may be combined or omitted such as, for example, not including the communications interface 308. In some embodiments, the electronic device 300 may comprise other components not combined or comprised in those shown in FIG. 7. For example, the electronic device 300 also may comprise a power subsystem. In other embodiments, the electronic device 300 may comprise several instances of the components shown in FIG. 7. For example, the electronic device 300 may comprise multiple memory subsystems 306. For the sake of conciseness and clarity, and not limitation, one of each of the components is shown in FIG. 7.

The processor subsystem 302 may comprise any processing circuitry operative to control the operations and performance of the electronic device 300. In various parameters, the processor subsystem 302 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 302 also may be implemented by a controller, a microcontroller, an application specific integrated circuit (ASIC), a field programmable gate array (FPGA), a programmable logic device (PLD), and so forth.

In various parameters, the processor subsystem 302 may be arranged to run an operating system (OS) and various applications. Examples of an OS comprise, for example, operating systems generally known under the trade name of Apple OS, Microsoft Windows OS, Android OS, and any other proprietary or open source OS. Examples of applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 300 may comprise a system bus 310 that couples various system components including the processing subsystem 302, the input/output subsystem 304, and the memory subsystem 306. The system bus 310 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 304 may comprise any suitable mechanism or component to at least enable a user to provide input to the electronic device 300 and the electronic device 300 to provide output to the user. For example, the input/output subsystem 304 may comprise any suitable input mechanism, including but not limited to, a button, keypad, keyboard, click wheel, touch screen, or motion sensor. In some embodiments, the input/output subsystem 304 may comprise a capacitive sensing mechanism, or a multi-touch capacitive sensing mechanism.

In some embodiments, the input/output subsystem 304 may comprise specialized output circuitry associated with output devices such as, for example, an audio peripheral output device. The audio peripheral output device may comprise an audio output including on or more speakers integrated into the electronic device. The speakers may be, for example, mono or stereo speakers. The audio peripheral output device also may comprise an audio component remotely coupled to audio peripheral output device such as, for example, a headset, headphones, and/or ear buds which may be coupled to the audio peripheral output device through the communications subsystem 308.

In some embodiments, the input/output subsystem 304 may comprise a visual peripheral output device for providing a display visible to the user. For example, the visual peripheral output device may comprise a screen such as, for example, a Liquid Crystal Display (LCD) screen, incorporated into the electronic device 300. As another example, the visual peripheral output device may comprise a movable display or projecting system for providing a display of content on a surface remote from the electronic device 300. In some embodiments, the visual peripheral output device can comprise a coder/decoder, also known as a Codec, to convert digital media data into analog signals. For example, the visual peripheral output device 402 may comprise video Codecs, audio Codecs, or any other suitable type of Codec.

The visual peripheral output device also may comprise display drivers, circuitry for driving display drivers, or both. The visual peripheral output device may be operative to display content under the direction of the processor subsystem 302. For example, the visual peripheral output device may be able to play media playback information, application screens for application implemented on the electronic device 300, information regarding ongoing communications operations, information regarding incoming communications requests, or device operation screens, to name only a few.

In some embodiments, the input/output subsystem 304 may comprise a virtual input/output system. The virtual input/output system is capable of providing input/output options by combining one or more input/output components to create a virtual input type. For example, the virtual input/output system may enable a user to input information through an onscreen keyboard which utilizes the touch screen and mimics the operation of a physical keyboard or using a motion sensor to control a pointer on the screen instead of utilizing the touch screen. As another example, the virtual input/output system may enable alternative methods of input and output to enable use of the device by persons having various disabilities. For example, the virtual input/output system may convert on-screen text to spoken words to enable reading impaired persons to operate the device.

In some embodiments, the communications interface 308 may comprises any suitable hardware, software, or combination of hardware and software that is capable of coupling the electronic device 300 to one or more networks and/or additional devices (such as, for example, the vent sensor 4 and/or the flow controller 8). The communications interface 308 may be arranged to operate with any suitable technique for controlling information signals using a desired set of communications protocols, services or operating procedures. The communications interface 308 may comprise the appropriate physical connectors to connect with a corresponding communications medium, whether wired or wireless.

Vehicles of communication comprise a network. In various parameters, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, smart devices such as those discussed herein, and/or any other suitable smart device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various parameters, the communications interface 308 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 308 may comprise a wireless interface comprising one or more antennas, transmitters, receivers, transceivers, amplifiers, filters, control logic, and so forth.

In various parameters, the communications interface 308 may provide voice and/or data communications functionality in accordance with different types of cellular radiotelephone systems. In various implementations, the described parameters may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with ixRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.1 with Enhanced Data Rate (EDR), v3.0 with Enhanced Data Rate (EDR), v4.0 low energy (LE), v4.1, v4.2. v5.0, as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, and so forth.

In various implementations, the described parameters may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

In some embodiments, the memory subsystem 306 may comprise any machine readable or computer-readable media capable of storing data, including both volatile/non-volatile memory and removable/non-removable memory. The memory subsystem 306 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the electronic device 300.

In various parameters, the memory subsystem 306 may comprise any machine readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 306 may contain a software program for transmitting and/or receiving customization information and/or data mining elements. In one embodiment, the memory subsystem 306 may contain an instruction set, in the form of a file for executing a method of customization on the electronic smart device 100. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments, a compiler or interpreter is comprised to convert the instruction set into machine executable code for execution by the processing subsystem 302.

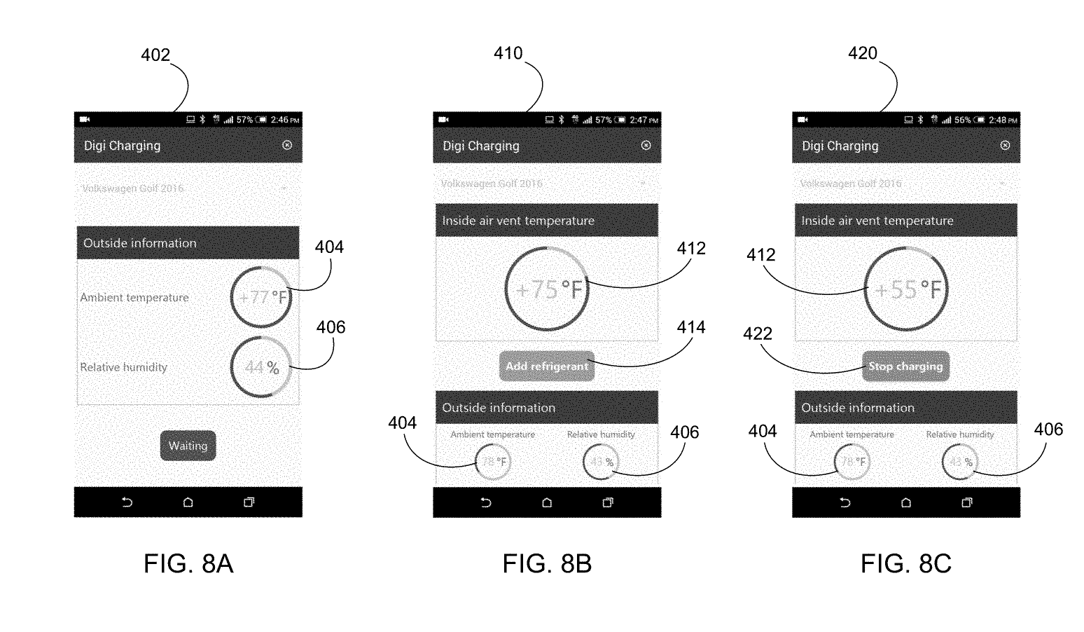

FIGS. 8A-8C illustrate a plurality of exemplary user interface screens that can be generated and/or present by the computing device 6, 300 to facilitate a recharge operation of an air conditioning system. Although exemplary user interface screens are included herein, it will be appreciated that alternative and/or additional user interface screens can be generated by the computing device 6, 300. In addition, it will be appreciated that a recharge operation, such as according to the method 200 discussed above, can be conducted without the use of user interface screens in some embodiments.

FIG. 8A illustrates a user interface screen 402 illustrating an ambient environmental measuring step. The user interface screen 402 shows a measured ambient temperature 404 and a measured ambient relative humidity 406, although it will be appreciated that additional and/or alternative environmental parameters can be measured. FIG. 8B illustrates a user interface screen 410 illustrating a charging operation of an air conditioning system, such as air conditioning system 610, 652. A vent sensor, such as vent sensor 4, has provided a temperature 412 of an output air flow of the air conditioning system. Based on the output temperature, the computing device 6 has determined that additional refrigerant is to be added to the air conditioning system, as indicated at interface element 414. FIG. 8C illustrates a user interface screen 420 illustrating a completed charging operation of the air conditioning system. The vent sensor 4 indicates the output air temperature 412 of the air conditioning system 610, 652 has decreased, for example, from 75° F. to 55° F. The computing device 6 determines that the acceptable refrigerant level has been achieved (for example, based on the ambient temperature, ambient humidity, and measured air flow output temperature of 55° F.), as indicated at interface element 422. Although example screens have been illustrated and discussed, it will be appreciated that alternative and/or additional user interface screens can be generated by the computing device 6.

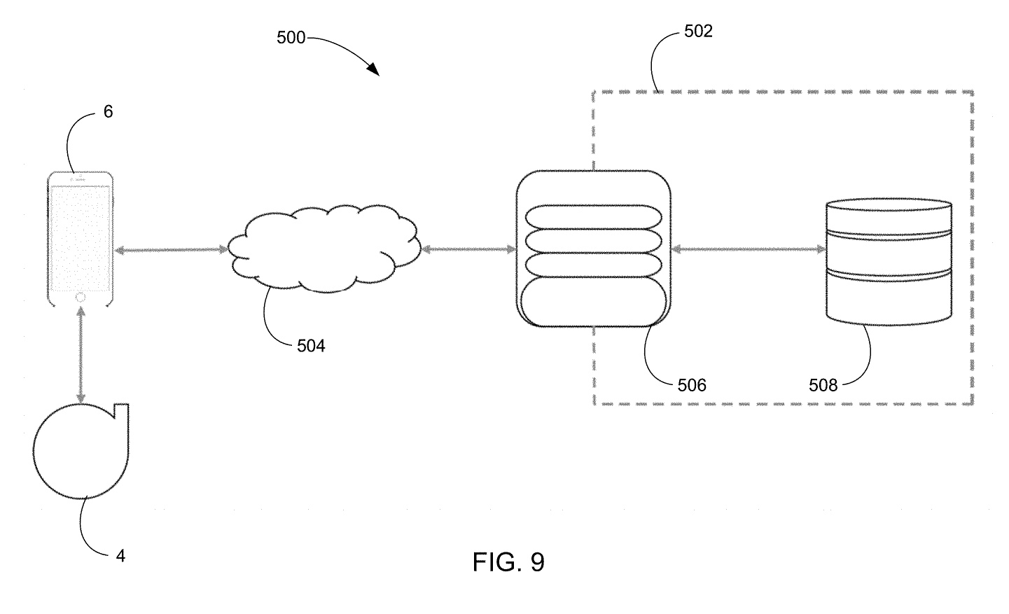

FIG. 9 illustrates a system 500 for monitoring and recharging an air conditioning system, in accordance with some embodiments. The system 500 is similar to the system 2 discussed above and similar description is not repeated herein. The system 500 includes a remote server 502 configured to receive data from the computing device 6 and perform one or more operations. For example, in some embodiments, the remote server 502 is configured to receive data regarding a current and/or prior level of efficiency of an air conditioning system, data regarding refrigerant added to an air conditioning system, and/or any other suitable data. The remote server 502 can be configured to store the data and/or perform additional operations with the data.

For example, in some embodiments, the remote server 502 is configured to compare a current level of efficiency of an air conditioning system with one or more stored previous level of efficiency of an air conditioning system. By comparing current and prior level of efficiency and the operation to restore a satisfactory level of efficiency, the remote server 502 can calculate and/or track refrigerant use and/or loss over a predetermined time period. Similarly, in some embodiments, the remote server 502 can be configured to track charging information for multiple air conditioning systems, such as multiple vehicles and/or structures.

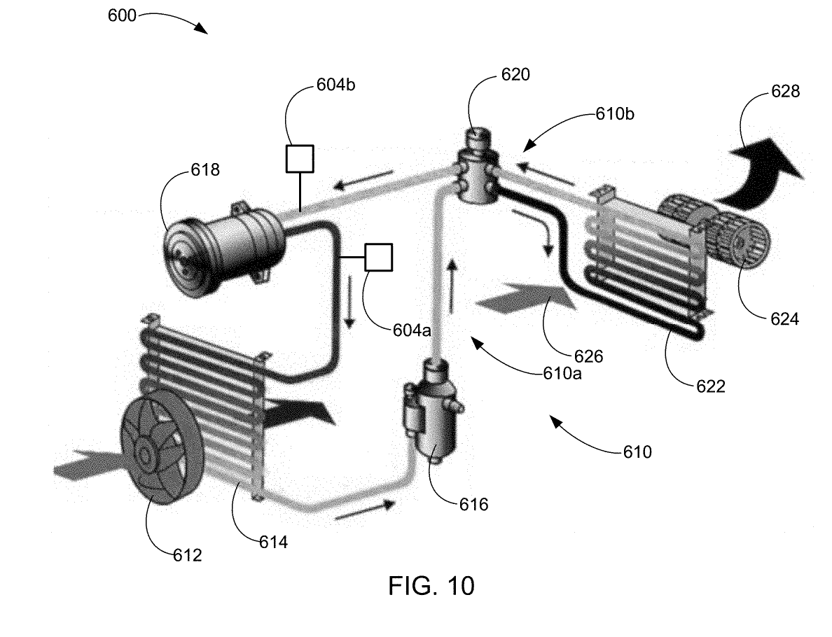

FIG. 10 illustrates a system 600 for monitoring and performing a recharge operation of a vehicle air conditioning system 610 having a high-pressure side 610a and a low pressure side 610b, in accordance with some embodiments. The vehicle air conditioning system 610 is similar to the air conditioning system 102 discussed above, and similar description is not repeated herein. The vehicle air conditioning system 610 includes an intake fan 612 configured to draw air from an ambient environment. The intake fan 612 directs the air flow over a condenser 614. The condenser 614 receives a high-pressure flow of a refrigerant in a gas phase and cools the refrigerant to a liquid phase. The liquid phase refrigerant is passed from the condenser 614 to a drier 616, which further dries the refrigerant. An expansion valve 620 receives the refrigerant from the high-pressure side 610a of the system 610 and transitions the refrigerant to the low-pressure side 610b. The refrigerant flows from the expansion valve 620 to an evaporator 622. The evaporator 622 is configured to remove humidity from and cool the air flow 626 received from the environment, such as from an ambient environment of a vehicle and/or from a passenger compartment. The cooled air flow is provided to a blower 624 which directs the cooled/low-humidity air flow 628 into a passenger compartment of the vehicle (not shown). The refrigerant flow through the evaporator 622 is heated from a low-pressure liquid flow to a low-pressure gas flow. The expansion valve 620 receives the low-pressure gas flow and provides the gas flow to a compressor 618. The compressor 618 compresses the low pressure gas flow of the low-pressure side 610b to a high-pressure gas flow of the high-pressure side 610a.

In some embodiments, the system 600 includes a first sensor 604a coupled to the high-pressure side port of the air conditioning system 610 and a second sensor 604b coupled to the low-pressure side port of the air conditioning system 610. Each of the first sensor 604a and the second sensor 604b are configured to monitor the pressure of respective high-pressure side 610a and low-pressure side 610b of the air conditioning system. The sensors 604a, 604b transmit a pressure reading to a remote system, such as computing device 6. The computing device 6 receives the pressure readings from each of the first sensor 604a and the second sensor 604b and determines the current status of the air conditioning system 610. The remote computing device 6 can include, but is not limited to, a car computer, a personal computing device, a cell phone, a remote data center, etc. For example, in some embodiments, the computing device 6 performs air conditioning system diagnostics to compare the ambient environmental information, the high-pressure side 610a, and the low-pressure side 610b pressure readings, to determine whether the air conditioning system is working at a satisfactory efficiency.

In some embodiments, a charging reservoir, such as charging reservoir 40 discussed above, can be coupled to one of the high-pressure side 610a and/or the low-pressure side 610b. The computing device 6 can be configured to control operation of the charging reservoir, for example through a flow controller 8 as discussed above, to increase and/or decrease the pressure of a respective high-pressure side 610a and/or a low-pressure side 610b of the air conditioning system 610 in order to maintain a satisfactory efficiency. [0087] FIG. 11 illustrates a system 650 for monitoring and performing a recharge operation of a room (or home) air conditioning system 652 having a high-pressure side 652a and a low-pressure side 652b, in accordance with some embodiments. The room (or home) air conditioning system 652 is similar to the vehicle air conditioning system 610 discussed in conjunction with FIG. 10, and similar description is not repeated herein. In some embodiments, a first sensor 604a is coupled to high-pressure side port and a second sensor 604b is coupled to the low-pressure side port of the air conditioning system 652. The first and second sensors 604a, 604b can be in communication with a remote computing device 6. The remote computing device 6 can include, but is not limited to, a home thermostat, a smart-home hub, a personal computing device, a cell phone, a remote data center, etc. The remote computing device 6 can be configured to perform air conditioning system diagnostics. The remote computing device 6 is configured to receive pressure readings from each of the first and second sensors 604a, 604b to determine whether the air conditioning system is working at a satisfactory efficiency.

In some embodiments, the computing device 6 in signal communication with the first and second sensors 604a, 604b can be configured to control operation of the air conditioning system 652. For example, in some embodiments, the computing device 6 includes a home thermostat or smart-home hub configured to control operation of the air conditioning system 652. The computing device 6 can be configured to activate and/or deactivate the air conditioning system 652 based on one or more parameters. In some embodiments, the computing device 6 is configured to generate an alert and/or other notification when the refrigerant level in the air conditioning system 652 is below a range of acceptable levels. The computing device 6 can be configured to automatically adjust refrigerant charge level of the air conditioning system 652 from a charging reservoir coupled to the air conditioning system 652 in order to maintain a satisfactory efficiency.

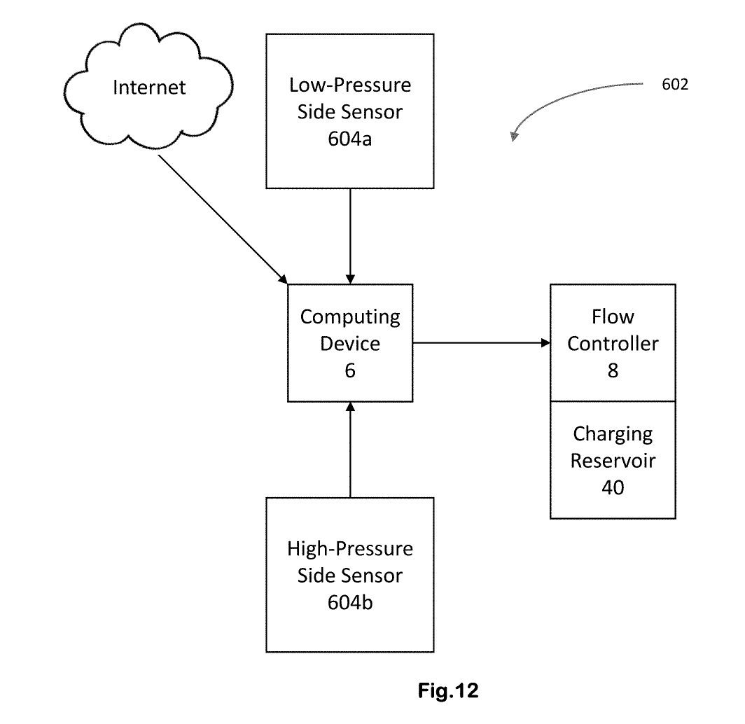

FIG. 12 illustrates one embodiment of a system 602 for monitoring and recharging an air conditioning system, in accordance with some embodiments. The system 602 is similar to the system 2 discussed above, and similar description is not repeated herein. The system 602 includes a first pressure sensor 604a, a second pressure sensor 604b, and a computing device 6. The computing device 6 can be configured to receive data from and/or transmit data to the Internet using any suitable communication protocol and/or medium, such as GSM, 2G, 3G, 4G, Bluetooth, WiFi, Near-Field Communication (NFC), TCP/IP, Ethernet, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, etc. For example, in some embodiments, the computing device 6 can be configured to download the parameters of the ambient environment around the air conditioning system, such as ambient temperature, ambient humidity, etc., from an Internet source, like the Weather Channel web site or other suitable source. The pressure sensors 604a, 604b are configured to couple to low-pressure side port and/or a high-pressure side port of an air conditioning system (see, for example, FIGS. 10-11). The pressure sensors 604a, 604b each include at least one intake configured to receive a portion of a fluid flow from a high-pressure and/or low-pressure side of the air conditioning system. The pressure sensors 604a, 604b each receive the fluid flow and measures a pressure of the respective fluid flow. In some embodiments, the pressure sensors 604a, 604b can be configured to measure additional parameters, such as, for example, temperature of the fluid flow, rate of the fluid flow, etc.

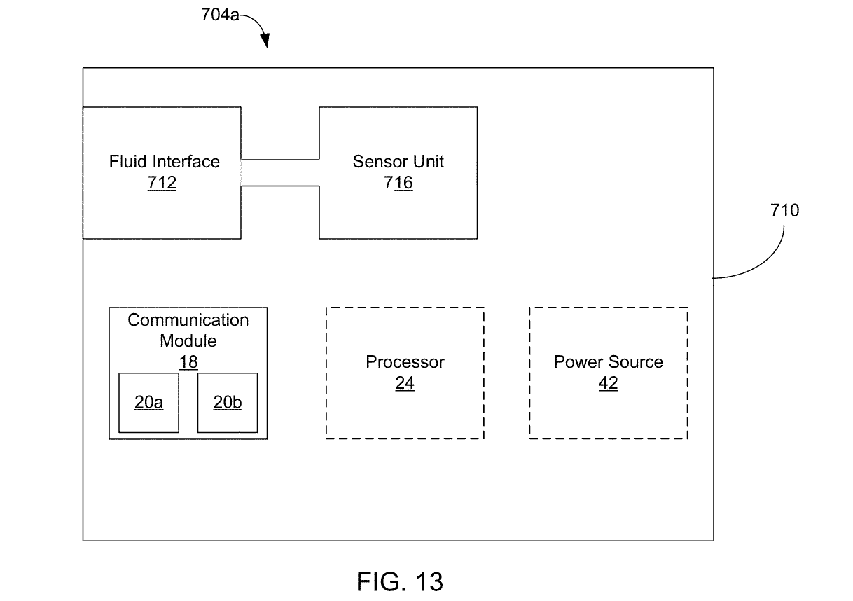

FIG. 13 illustrates a pressure sensor 704a, in accordance with some embodiments. The pressure sensor 704a is configured for use with a system monitoring the high-pressure side and/or low-pressure side of an air conditioning system, such as, for example, systems 600, 650 discussed in conjunction with FIGS. 10 and 11. The pressure sensor 704a is similar to the sensor 604 discussed in conjunction with FIG. 12, and similar description is not repeated herein. In some embodiments, the pressure sensor 704a includes a fluid interface 712 configured to interact with and/or otherwise receive fluid from one of a high-pressure side or a low-pressure side of an air conditioning system. As used herein, the term fluid refers to a flow of material in one of a liquid or a gas phase.

The sensor unit 716 is electrically coupled to a communication module 18. The communication module 18 is configured to receive from the sensor unit 716 a signal indicative of the one or more measured parameters of the pressure and transmit the signal to a remote device, such as the computing device 6 and/or a remote monitoring data center. The communication module 18 can include a wired communication module 20a and/or a wireless communication module 20b. For example, in some embodiments, the communication module 18 can include a wired communication module 20a using one or more wired communication protocols, such as TCP/IP, UDP, Serial, Parallel, and/or any other suitable wired communication, as discussed in more detail below. As another example, in some embodiments, the communication module 18 can include a wireless communication module 20b using one or more wireless communication protocols, such as Bluetooth, NFC, RFID, WiFi, 802.11a/b/c/g, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, and/or any other suitable wireless communication protocol, as discussed in more detail below.

Although embodiments are illustrated herein including a fluid interface 712, a sensor unit 716, and a communication module 18, it will be appreciated that the pressure sensor 704a can include fewer, additional, and/or alternative embodiments to those illustrated herein and are within the scope of this disclosure, such as, for example, a power source 42, a processor 24, and/or any other suitable circuit or physical elements. In some embodiments, the power source 42 can be a solar power source.

The pressure of the fluid is measured by a sensor unit 716 coupled to the fluid interface 712. The sensor unit 716 can include any suitable sensor configured to measure a pressure of a fluid flow. The sensor unit 716 is configured to provide the pressure reading to one of a communication module 18 and/or a processor 24 for transmission to a remote computing device, such as computing device 6 discussed above. In some embodiments, the sensor unit 716 can include a power source 42 for powering one or more elements, such as a processor 24, a communications module 18, and/or the sensor unit 716.

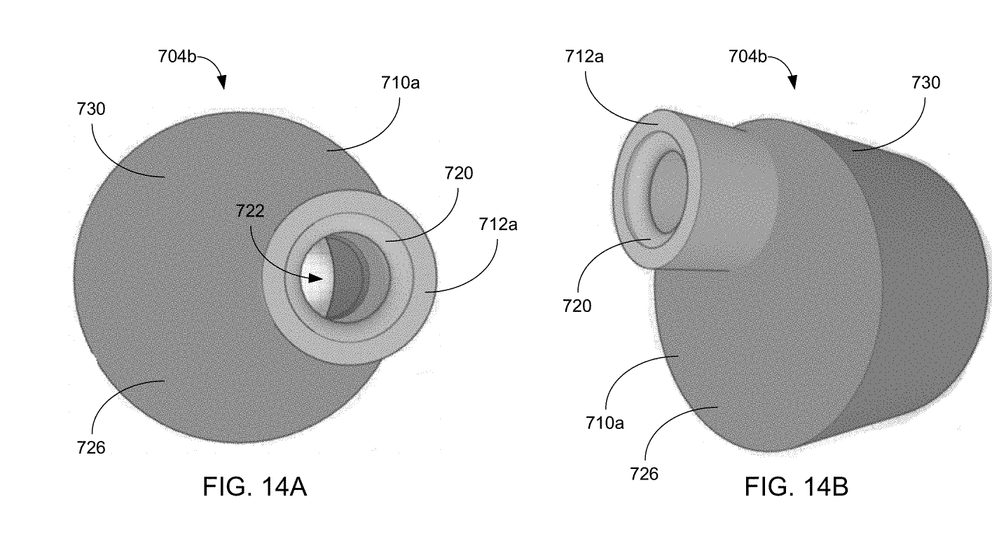

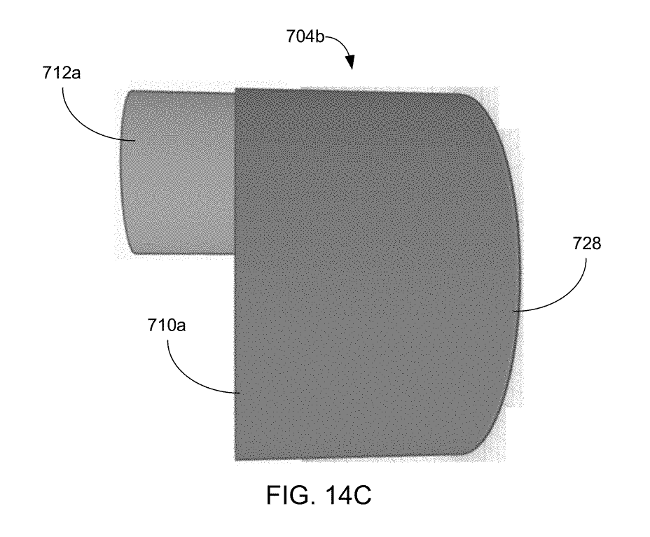

FIGS. 14A-14C illustrate a pressure sensor 704b, in accordance with some embodiments. The pressure sensor 704b is similar to the pressure sensor 704a discussed above, and similar description is not repeated herein. The pressure sensor 704b includes a cylindrical body 710a. The cylindrical body 710a includes an intake face 726, a rear face 728, and a sidewall 730 extending therebetween. In the illustrated embodiment, the intake face 726 and the rear face 728 have similar diameters, although it will be appreciated that the intake face 726 can have a greater and/or lesser diameter than the rear face 728.

The intake face 726 defines a fluid interface 712a . The interface 712a includes a circular opening extending through the intake face 726 to an internal volume 722 of the pressure sensor 704b. The interface 712a can be positioned in any suitable location on the intake face 726. For example, in the illustrated embodiment, the interface 712a is offset on the intake face 726, although it will be appreciated that the interface 712a can be centered on the intake face 726 and is within the scope of this disclosure. In the illustrated embodiment, the interface 712a functions as an input/output and allows fluid flow into and out of the body 710a of the pressure sensor 704b. In other embodiments, an exhaust face 728 can define an output that provides a fluid flow path connected to the air conditioning system 610, 652 below the interface 712a.

In some embodiments, the interface 712a can serve as an attachment mechanism for coupling the pressure sensor 704b to a high-pressure and/or low-pressure side of an air conditioning system. For example, in the illustrated embodiment, the interface 712a includes an o-ring 720 configured to provide a fluid tight seal with an access valve of an air conditioning system (see, for example, FIGS. 10-11). The o-ring 720 maintains the body 710a in a fixed position and further provides a fluid-tight seal to prevent liquid coolant from escaping from the air conditioning system during monitoring and/or recharging operation.

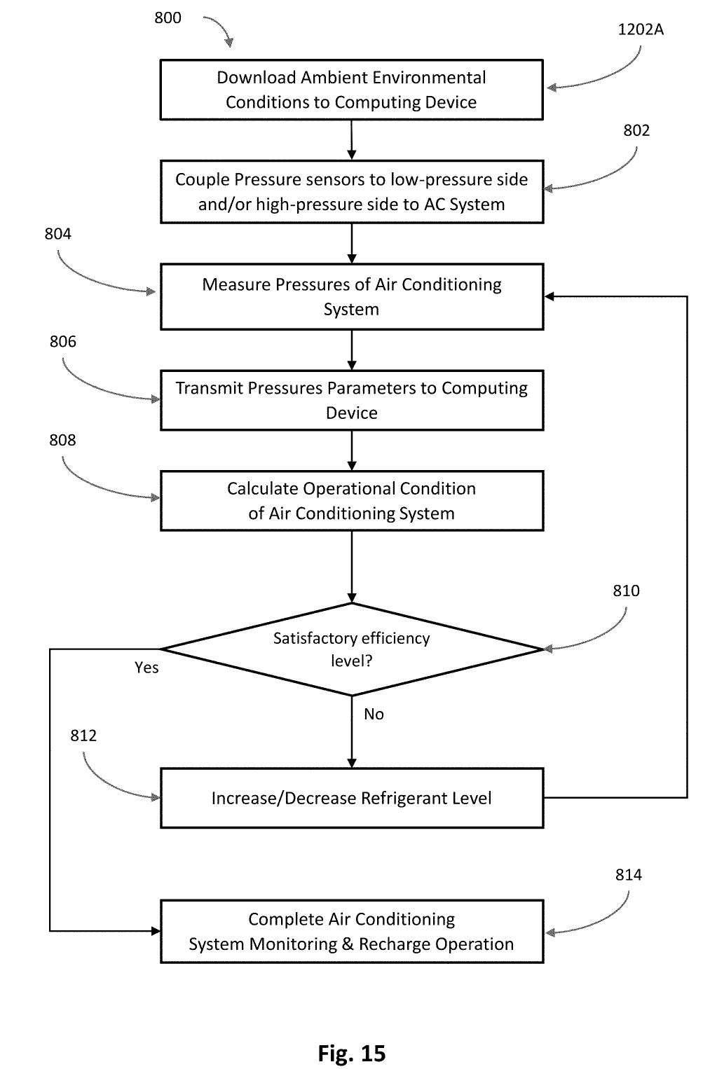

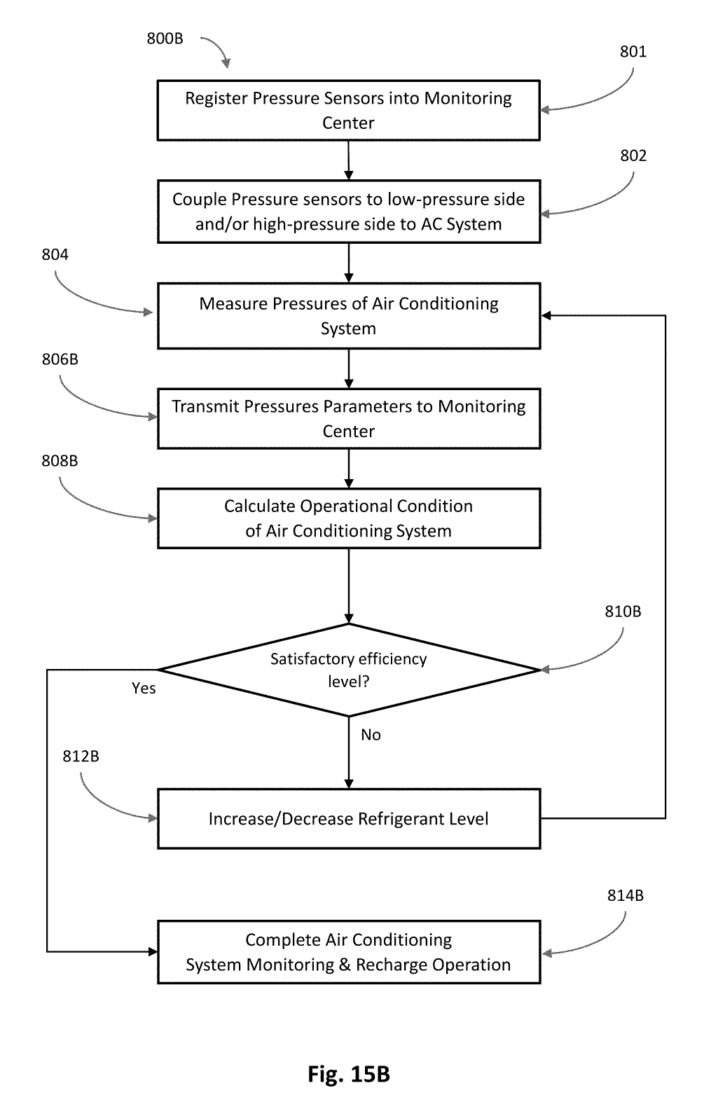

FIG. 15 illustrates a method 800 of recharging an air conditioning system, such as the air conditioning systems 610, 652 illustrated in FIGS. 10-11, using a monitoring and recharge system, such as the system 602 discussed above, in accordance with some embodiments. At step 1202A, one or more ambient environmental conditions, such as ambient temperature and/or ambient humidity, are downloaded from the Internet to the computing device. For example, in some embodiments, the computing device can be linked with the Weather Channel web site and download ambient temperature and humidity. The ambient environmental conditions can be transmitted using any suitable protocol over any suitable medium, as discussed herein.

At step 802, one or more pressure sensors 604a, 604b are coupled to a high pressure side 610a, 652a and/or a low-pressure side 610b, 652b of the air conditioning system 610, 652. The pressure sensors 604a, 604b can be coupled to the respective high- and/or low pressure sides using any suitable attachment mechanism, such as, for example, an o-ring and/or any other suitable attachment. The pressure sensors 604a, 604b are coupled to the respective pressure sides such that fluid flow from is directed towards and/or into fluid interface 712 formed in the respective pressure sensor 604a, 604b.

At step 804, the pressure sensors 604a, 604b each measure a pressure of a respective fluid flow (i.e., high-pressure/low-pressure) of the air conditioning system 610, 652. The pressure of the respective fluid flow is measured by a sensor unit 716 formed integrally with the pressure sensor 604a, 604b. The sensor unit 716 includes one or more sensors configured to measure the pressure of the fluid flow.

At step 806, the measured pressure is provided to the computing device 6. The measured pressure can be provided using any suitable communications system, such as, for example a wireless communication module 20a and/or wired communication module 20b. The measured pressure can be transmitted using any suitable protocol over any suitable medium, as discussed herein.

At step 808, the computing device 6 determines the current operational state of the air conditioning system 610, 652 such as the operating parameters of the air conditioning system 610, 652 and determines, at step 810, whether the air conditioning system 610, 652 is working at a satisfactory efficiency. The computing device 6 can utilize one or more algorithms, parameters and/or other functions to determine if the air conditioning system is working at a satisfactory efficiency. For example, in some embodiments, a correlation between the ambient humidity and the ambient temperature around the air conditioning system 610, 652, expressed with a temperature and relative humidity performance test table, can be used to determine the optimal high-pressure side pressure measurement and the optimal low-pressure side pressure measurement of the air conditioning system 610, 652. Sensing air conditioner pressures provides more information about the air conditioning system, not just in order to determine the level of efficiency but also about potential issues that do not involve directly the level of refrigerant. For example, in some embodiments, measurement of a low-pressure side pressure higher than the optimal low-pressure side pressure indicates that the air conditioner compressor has failed or has some other serious issue. In the case of compressor failure, adding or removing refrigerant will not restore the air conditioner to a satisfactory level of efficiency.

If the computing device 6 determines that the air conditioning system is not operating at an acceptable efficiency level and determines that refrigerant should be added to or removed from the air conditioning system 610, 652, then the method 800 proceeds to step 812. If the computing device 6 determines the air conditioning system is operating at an acceptable efficiency level, then the method 800 proceeds to step 814. At step 812, refrigerant is added to and/or removed from the air conditioning system 610, 652. A flow controller 8 can be operated to add and/or remove the refrigerant in order to restore a satisfactory efficiency level. In some embodiments, the flow controller 8 is controlled by the computing device 6. For example, in some embodiments, the computing device 6 generates a signal based on the calculated level of efficiency in the air conditioning system 610, 652. If the current level of efficiency is determined to be low, then the flow controller 8 is operated to add or remove refrigerant to the air conditioning system 610, 652.

The method 800 repeats steps 804-812 as necessary to obtain a satisfactory efficiency level of the air conditioning system 610, 652. The method 800 can repeat the steps of measuring one or more parameters of fluid flow pressure, calculating the efficiency level, and adjusting the refrigerant level as needed. When the computing device 6 determines that an acceptable efficiency level has been reached, the method 800 proceeds to step 814. At step 814, the recharge operation is completed. In some embodiments, the computing device 6 can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the computing device 6 can be provided to a remote server for storage, comparison, collation, and/or any other suitable use.

FIG. 15B illustrates a method 800B of recharging an air conditioning system, such as the air conditioning systems 610, 652 illustrated in FIGS. 10-11, using a monitoring and recharge system, such as the system 602 discussed above, in accordance with some embodiments. At step 801 the pressure sensors are registered into monitoring data center by the user. Using any suitable device, for example, a cell phone, the user provides to the monitoring data center information about the sensors, such as, for example, geolocation, identification number, air conditioner model, type of refrigerant, etc. Depending on the embodiment, the user can be the air conditioning service company, the homeowner, the car owner, etc.

At step 802, one or more pressure sensors 604a, 604b are coupled to a high pressure side 610a, 652a and/or a low-pressure side 610b, 652b of the air conditioning system 610, 652. The pressure sensors 604a, 604b can be coupled to the respective high- and/or low pressure sides using any suitable attachment mechanism, such as, for example, an o-ring and/or any other suitable attachment. The pressure sensors 604a, 604b are coupled to the respective pressure sides such that fluid flow is directed towards and/or into fluid interface 712 formed in the respective pressure sensor 604a, 604b.

At step 804, the pressure sensors 604a, 604b each measure a pressure of a respective fluid flow (i.e., high-pressure/low-pressure) of the air conditioning system 610, 652. The pressure of the respective fluid flow is measured by a sensor unit 716 formed integrally with the pressure sensor 604a, 604b. The sensor unit 716 includes one or more sensors configured to measure the pressure of the fluid flow.

At step 806B, the measured pressure is provided to the monitoring data center. The measured pressure can be provided using any suitable communications system, such as, for example, a wireless communication module 20a and/or wired communication module 20b. The measured pressure can be transmitted using any suitable protocol over any suitable medium, as discussed herein.

At step 808B, the monitoring data center determines the current operational state of the air conditioning system 610, 652 such as the operating parameters of the air conditioning system 610, 652 and determines, at step 810B, whether the air conditioning system 610, 652 is working at a satisfactory efficiency. The monitoring data center can utilize one or more algorithms, parameters, and/or other functions to determine if the air conditioning system is working at a satisfactory efficiency. For example, in some embodiments, a correlation between the ambient humidity and the ambient temperature around the air conditioning system 610, 652, expressed with a temperature and relative humidity performance test table, can be used to determine the optimal high-pressure side pressure measurement and the optimal low-pressure side pressure measurement of the air conditioning system 610, 652.

If the monitoring data center determines that the air conditioning system satisfactory efficiency level is not at an acceptable level and determine that refrigerant should be added to or removed from the air conditioning system 610, 652, then the method 800B proceeds to step 812B. If the monitoring data center determines that the air conditioning system is operating at an acceptable efficiency level, then the method 800B proceeds to step 814B. At step 812B, refrigerant is added to and/or removed from the air conditioning system 610, 652. A flow controller 8 can be operated to add and/or remove the refrigerant in order to restore a satisfactory efficiency level. In some embodiments, the flow controller 8 is controlled by the monitoring remote data center. For example, in some embodiments, the monitoring remote data center generates a signal based on the calculated level of efficiency of the air conditioning system 610, 652. If the current level of efficiency is determined to be low, then the flow controller 8 is operated to add or remove refrigerant to the air conditioning system 610, 652.

The method 800B repeats steps 804-812B as necessary to obtain a satisfactory efficiency level of the air conditioning system 610, 652. The method 800B can repeat the steps of measuring one or more parameters of fluid flow pressure, characterizing the efficiency level, and adjusting the refrigerant level as needed. When the monitoring data center determines that an acceptable efficiency level has been reached, the method 800B proceeds to step 814B. At step 814B, the recharge operation is completed. In some embodiments, the monitoring data center can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the monitoring data center can be provided to a remote server for storage, comparison, collation, and/or any other suitable use.

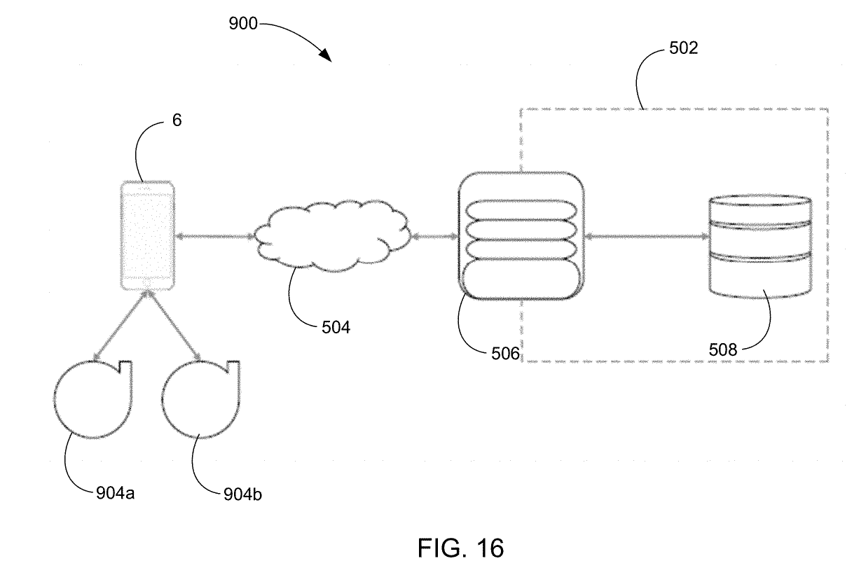

FIG. 16 illustrates a system 900 for monitoring and recharging an air conditioning system, in accordance with some embodiments. The system 900 is similar to the system 500 discussed above and similar description is not repeated herein. The system 900 includes a plurality of sensors 904a, 904b. In some embodiments, the plurality of sensors 904a, 904b can include a first pressure sensor and a second pressure sensor (such as pressure sensor 604 discussed above). In some embodiments, the plurality of sensors 904a, 904b can include a first vent sensor (such as vent sensor 4 discussed above) and at least one pressure sensor (such as pressure sensor 604 discussed above). In some embodiments including both a vent sensor and a pressure sensor, the system 900 can utilize both air flow parameters (e.g., temperature, humidity, etc.) and pressure parameters to measure and/or optimize an air conditioning system, such as the air conditioning system 610, 652.

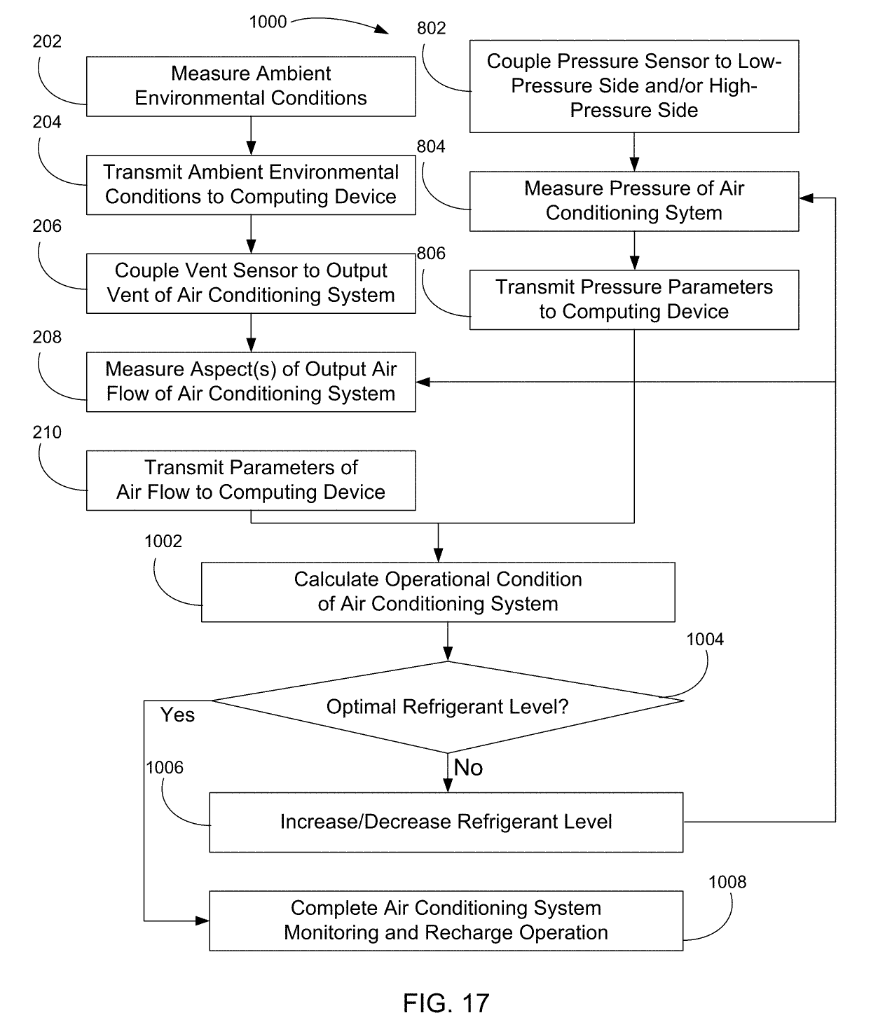

FIG. 17 illustrates a method 1000 of recharging an air conditioning system, such as the air conditioning systems 610 illustrated in FIG. 10 or the air conditioning system 652 illustrated in FIG. 11, using a monitoring and recharge system including one or more vent sensors, such as the vent sensor 4, and one or more pressure sensors, such as the pressure sensors 604a, 604b, in accordance with some embodiments. The method 1000 measures the environmental conditions and the parameters of the output air flow of the air conditioning system 610, 652 according to steps 202-210 of the method 200 discussed above. The method 1000 further measures the pressure of at least one of a high-pressure side and/or a low-pressure side of the air conditioning system 610, 652 according to the steps 802-806 of the method 800 discussed above.

At step 1002, the computing device 6 receives both the air flow parameters and the pressure measurements and determines the current operational state of the air conditioning system 610, 652 such as the operating parameters of the air conditioning system 610, 652 using at least one air flow parameters and the pressure measurement. For example, in some embodiments, the computing device 6 can be configured to compare an output temperature of the air conditioning system 610, 652, an ambient temperature of the environment, and one of a low pressure and/or high-pressure measurement of the air conditioning system 610, 652 to determine the current operational condition of the air conditioning system 610, 652, although it will be appreciated that any combination of air flow parameters (including ambient parameters or output air flow parameters) and/or pressure measurements (including low-side pressure and/or high-side pressure) can be utilized by the computing device 6 to determine the current operational condition of the air conditioning system 610, 652.

At step 1004, the computing device 6 determines whether the air conditioning system 610, 652 is working at satisfactory efficiency. The computing device 6 can utilize one or more algorithms, parameters and/or other functions to determine if the air conditioning system is working at satisfactory efficiency. If the computing device 6 determines that the efficiency level is not at an acceptable level and determines that refrigerant should be added or removed from the air conditioning system 610, 652, then the method 1000 proceeds to step 1006. If the computing device 6 determines the air conditioning system 610, 652 is at an acceptable level, then the method 1000 proceeds to step 108.

At step 1006, refrigerant is added to and/or removed from the air conditioning system 610, 652. A flow controller 8 can be operated to add and/or remove the refrigerant in order to restore a satisfactory efficiency. In some embodiments, the flow controller 8 is controlled by the computing device 6. For example, in some embodiments, the computing device 6 generates a signal based on the calculated current level of efficiency of the air conditioning system 610, 652. If the current level of efficiency is determined to be low, then the flow controller 8 is operated to add or remove refrigerant to the air conditioning system 610, 652.

The method 1000 repeats steps 208-210, 804-806, and 1002-1006 as necessary to obtain a satisfactory efficiency level of the air conditioning system 610, 652. When the computing device 6 determines that an acceptable efficiency level has been reached, the method 1000 proceeds to step 1008. At step 1008, the recharge operation is completed. In some embodiments, the computing device 6 can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the computing device 6 can be provided to a remote server for storage, comparison, collation, and/or any other suitable use

Although the subject matter has been described in terms of exemplary embodiments, it is not limited thereto. Rather, the appended claims should be construed broadly, to include other variants and embodiments, which may be made by those skilled in the art.

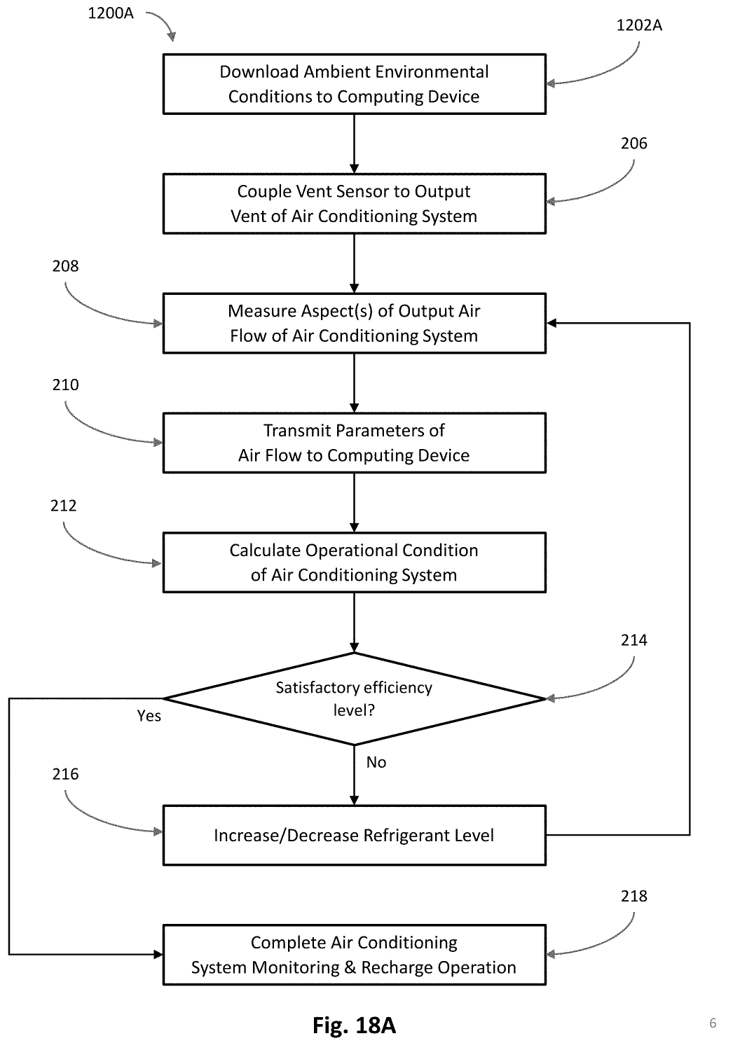

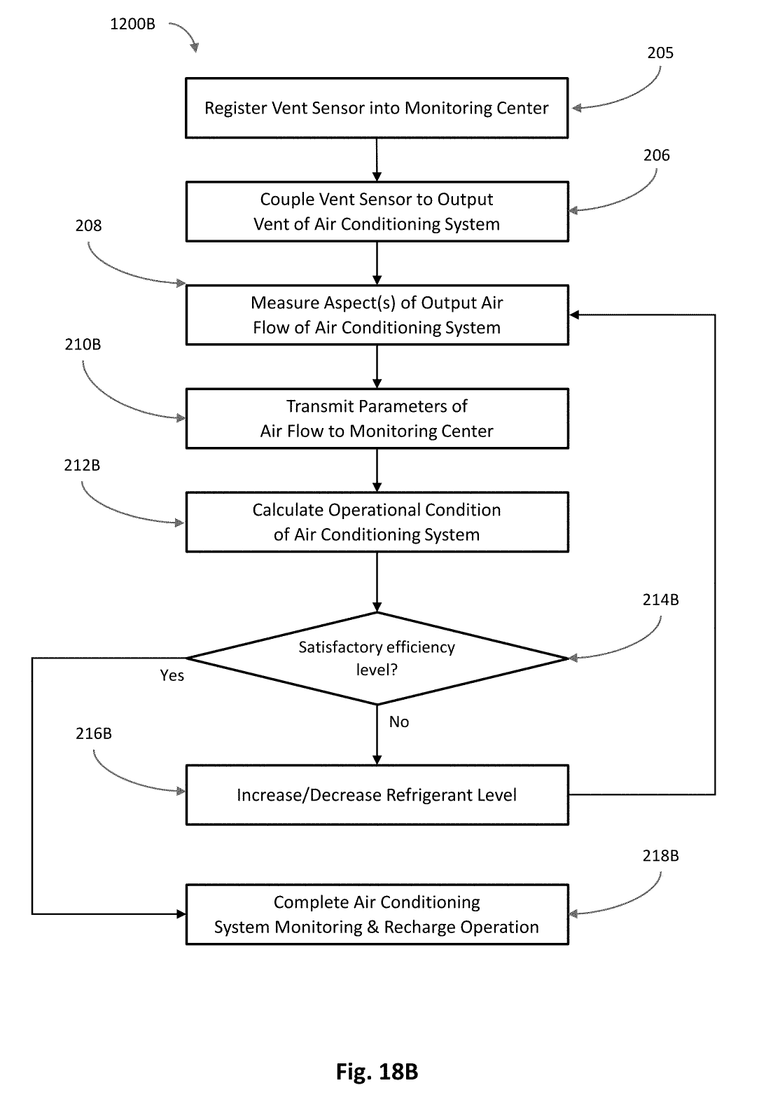

FIG. 18A illustrates a method 1200A of recharging an air conditioning system, such as the air conditioning system 102 illustrated in FIGS. 5A-5B and/or the room (or home) air conditioning 652 illustrated in FIG. 11 and described in detail below, using a monitoring and recharge system, such as the systems 2-2a discussed above, in accordance with some embodiments. The system is similar to the system 200 discussed above in FIG. 6, and similar description is not repeated.

At step 1202A, one or more ambient environmental conditions, such as ambient temperature and/or ambient humidity are downloaded from the Internet to the computing device. For example, in some embodiments, the computing device can be linked with the Weather Channel web site and download ambient temperature and humidity. The ambient environmental conditions can be transmitted using any suitable protocol over any suitable medium, as discussed herein.

FIG. 18B illustrates a method 1200B of recharging an air conditioning system, such as the air conditioning system 102 illustrated in FIGS. 5A-5B and/or the room (or home) air conditioning 652 illustrated in FIG. 11 and described in detail below, using a monitoring and recharge system, such as the systems 2-2a discussed above, in accordance with some embodiments. The system is similar to the system 200 discussed above in FIG. 6, and similar description is not repeated.

At step 205, the vent sensor is registered into the monitoring data center by the user. Using any suitable device, for example, a cell phone, the user provides to the monitoring data center information about the sensors, such as, for example, geolocation, identification number, air conditioner model, type of refrigerant, etc. Depending on the embodiment, the user can be the air conditioning service company, the homeowner, the car owner, etc. For implementations in which the ambient conditions (e.g., temperature and humidity) are downloaded from the Internet, the geolocation of the vent sensor is used to download the appropriate data. Depending the particular implementation, the geolocation information may be provided to the monitoring data center from the vent sensor or from the user's cell phone, and the monitoring data center uses that geolocation information to download data corresponding to the ambient conditions.

At step 210B, the one or more measured parameters of the air flow output are provided to the monitoring data center. The measured parameters can be provided using any suitable communications system, such as, for example wireless communication module 20a and/or wired communication module 20b. The measured parameters can be transmitted using any suitable protocol over any suitable medium, as discussed herein.

At step 212B, the monitoring data center determines the current operational state of the air conditioning system 610, 652, such as the operating parameters of the air conditioning system 610, 652, and determines, at step 214B, whether the air conditioning system 610, 652 is working at a satisfactory efficiency. The monitoring data center can utilize one or more algorithms, parameters, and/or other functions to determine if the air conditioning system is working at a satisfactory efficiency. For example, in some embodiments, a correlation between the ambient humidity and the ambient temperature around the air conditioning system 610, 652 expressed with a temperature and relative humidity performance test table, can be used to determine the optimal air flow output temperature of the air conditioning system 610, 652, although it will be appreciated that additional and/or alternative ambient and/or measured parameters can be used to determine the optimal level of refrigerant in the air conditioning system 610, 652.

For example, in some embodiments, the ambient temperature in a range of about 80-85° F. can be downloaded, for example, from the Weather Channel web site. At step 210B, a temperature of the air flow output of the air conditioning system is measured and compared to one or more additional ambient environmental parameters to determine if the air flow temperature falls outside of a predetermined acceptable range, such as, for example, 35-45° F. If the measured air flow output temperature is above 45° F., then the monitoring data center determines that the current level of refrigerant in the air conditioning system 610, 652 is not at a satisfactory level. Similarly, if the measured air flow output temperature is above 35° F. but below 45° F., then the monitoring data center determines that the current level of refrigerant in the air conditioning system 610, 652 is at a satisfactory level.

As another example, in some embodiments, the ambient humidity of about 90% can be downloaded, for example, from the Weather Channel web site. At step 210B, the humidity of the air flow output of the air conditioning system 610, 652 is measured and compared to one or more additional ambient environmental parameters to determine if the air flow humidity falls outside of a predetermined acceptable humidity range, such as 15-25%. If the measured air flow humidity is above 25%, then the monitoring data center determines that the air conditioning system 610, 652 is not working at a satisfactory efficiency level. Similarly, if the measured air flow humidity is above 15% but below 25%, then the monitoring data center determines that the air conditioning system 610, 652 is working at a satisfactory efficiency level. The ranges and/or ambient conditions discussed herein are provided only as examples, and it will be appreciated that the monitoring data center can determine an acceptable range based on any applicable ambient environmental conditions and/or air flow parameters.

If the monitoring data center determines that the air conditioning system is not operating at an acceptable efficiency level and determines that refrigerant should be added to or removed from the air conditioning system 610, 652, then the method 1200B proceeds to step 216B. If the monitoring data center determines the air conditioning system is operating at an acceptable level, then the method 1200B proceeds to step 218B. At step 216B, refrigerant is added to and/or removed from the air conditioning system 610, 652. A flow controller 8 can be operated to add and/or remove the refrigerant in order to restore a satisfactory efficiency level. In some embodiments, the flow controller 8 is controlled by the monitoring data center. For example, in some embodiments, the monitoring data center generates a signal based on the calculated current level of efficiency of air conditioning system 610, 652. If the current level of refrigerant is determined to be low, then the flow controller 8 is operated to add or remove refrigerant to the air conditioning system 610, 652.

Continuing one of the examples from above, if the measured air flow output temperature is above 45° F. (e.g., above the predetermined acceptable temperature range), then the monitoring data center activates the flow controller 8 to add and/or remove refrigerant to the refrigerant reservoir 106 of the air conditioning system 610, 652. It will be appreciated by those skilled in the art that different behaviors for different acceptable ranges and/or non-acceptable measurements are within the scope of this disclosure.

The method 1200B repeats steps 208-216B as necessary to obtain a satisfactory efficiency level of air conditioning system 610, 652. The method 1200B can repeat the steps of measuring one or more parameters of the output flow, characterizing the efficiency level, and adjusting the refrigerant level as needed. When the monitoring data center determines that an acceptable efficiency level has been reached, the method 1200B proceeds to step 218B. At step 218B, the recharge operation is completed. In some embodiments, the monitoring data center can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the monitoring data center can be provided to a remote server for storage, comparison, collation, and/or any other suitable use.

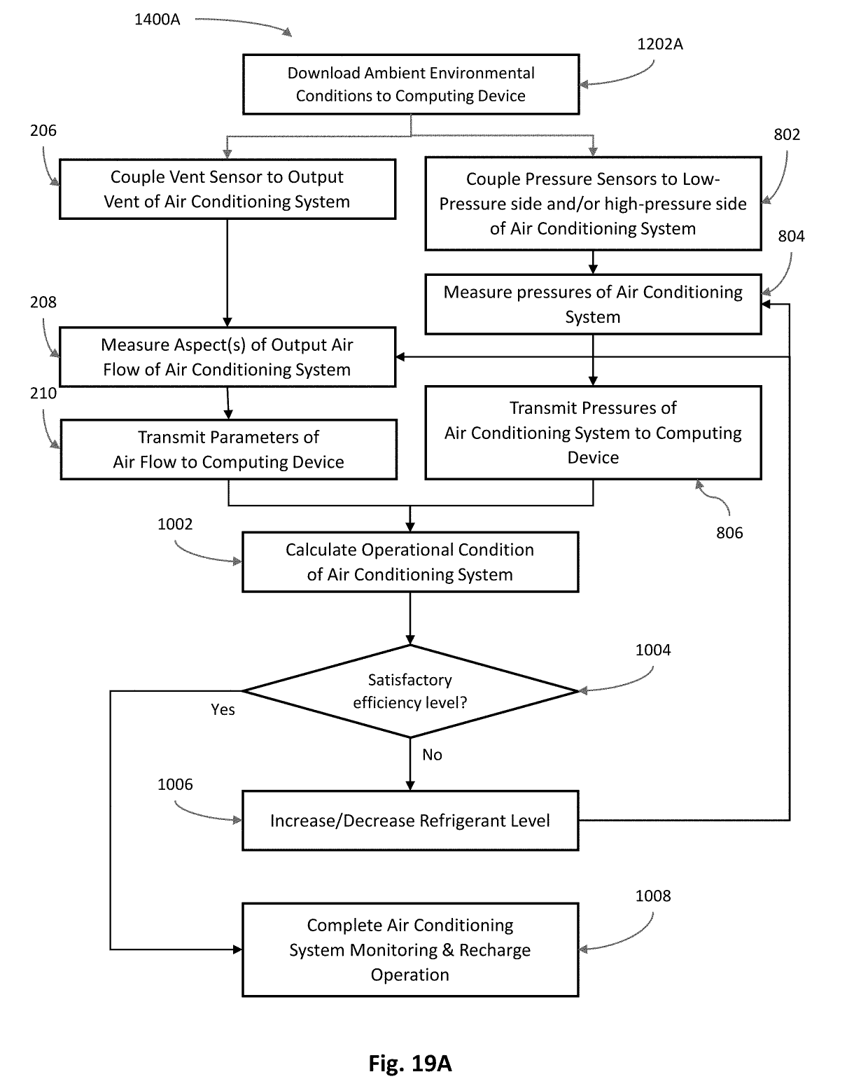

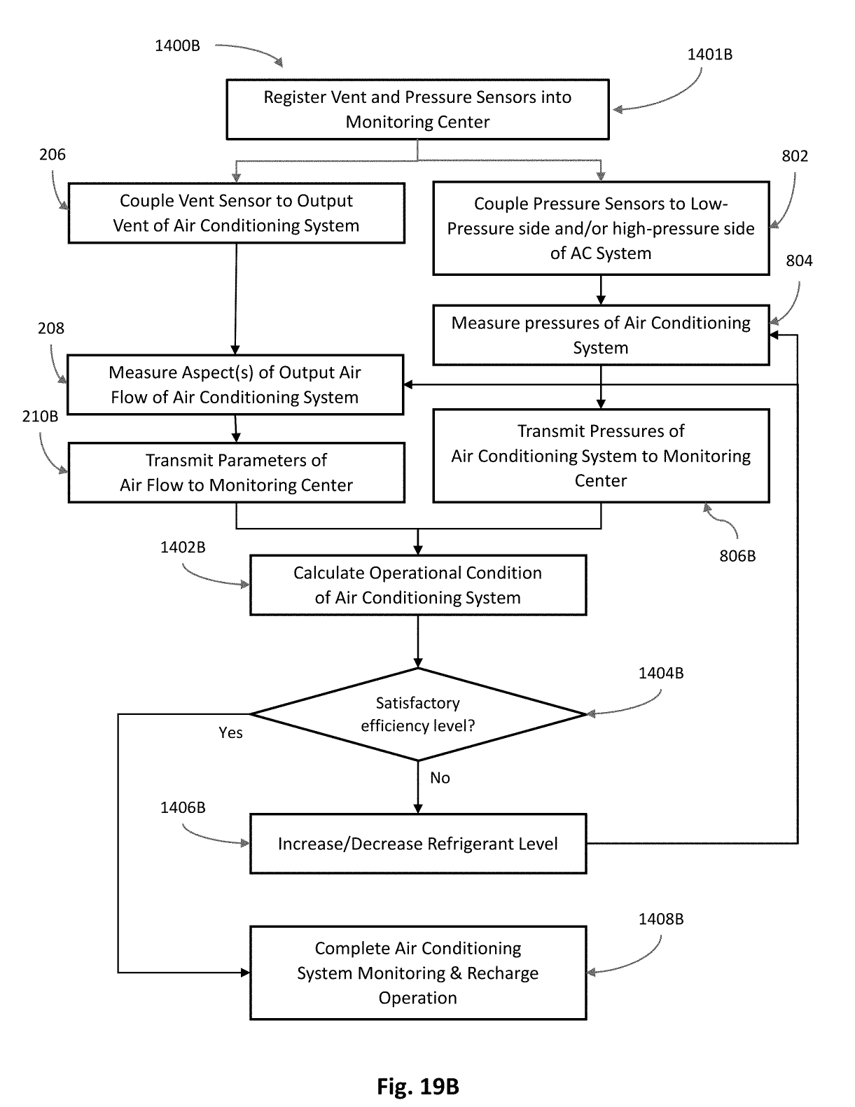

FIG. 19A illustrates a method 1400A of recharging an air conditioning system, such as the air conditioning systems 610 illustrated in FIG. 10 or the air conditioning system 652 illustrated in FIG. 11, using a monitoring and recharge system including one or more vent sensors, such as the vent sensor 4, and one or more pressure sensors, such as the pressure sensors 604a, 604b, in accordance with some embodiments. The system is similar to the system 1000 discussed above in FIG. 17, and similar description is not repeated. The method 1400A downloads from the Internet the ambient environmental conditions, such as ambient temperature and/or ambient humidity, according to step 1202A.

FIG. 19B illustrates a method 1400B of recharging an air conditioning system, such as the air conditioning systems 610 illustrated in FIG. 10 or the air conditioning system 652 illustrated in FIG. 11, using a monitoring and recharge system including one or more vent sensors, such as the vent sensor 4, and one or more pressure sensors, such as the pressure sensors 604a, 604b, in accordance with some embodiments. The system is similar to the system 1200B discussed above in FIG. 18B, and system 800B discussed above in FIG. 15B, and similar description is not repeated.

The method 1400B registers all sensors into the monitoring data center, such as vent and pressure sensors, according to step 1401B as explain above.

At step 1402B, the monitoring data center receives both the air flow parameters and the pressure measurements and determines the current operational state of the air conditioning system 610, 652 such as the operating parameters of air conditioning system 610, 652 using at least one air flow parameters and the pressure measurement. For example, in some embodiments, the monitoring data center can be configured to compare an output temperature of the air conditioning system 610, 652, an ambient temperature of the environment, and one of a low-pressure and/or high-pressure measurement of the air conditioning system 610, 652 to determine the current operational condition of the air conditioning system 610, 652, although it will be appreciated that any combination of air flow parameters (including ambient parameters or output air flow parameters) and/or pressure measurements (including low-side pressure and/or high-side pressure) can be utilized by the computing device 6 to determine the current operational condition of the air conditioning system 610, 652.

At step 1404B, the monitoring data center determines whether the air conditioning system 610, 652 is working at satisfactory efficiency. The monitoring data center can utilize one or more algorithms, parameters, and/or other functions to determine if the air conditioning system is working at satisfactory efficiency level. If the monitoring data center determines the air conditioning system 610, 652 is not at an acceptable level, then the method 1400B proceeds to step 1406B. If the monitoring data center determines the air conditioning system 610, 652 is at an acceptable level, then the method 1400B proceeds to step 1408B.

At step 1406B, refrigerant is added to and/or removed from the air conditioning system 610, 652. A flow controller 8 can be operated to add and/or remove the refrigerant in order to restore a satisfactory efficiency. In some embodiments, the flow controller 8 is controlled by the monitoring data center. For example, in some embodiments, the monitoring data center generates a signal based on the calculated current level of efficiency of air conditioning system 610, 652. If the current level of efficiency is determined to be low, then the flow controller 8 is operated to add or remove refrigerant to the air conditioning system 610, 652.

The method 1400A repeats steps 208-210B, 804-806B, and 1402B-1406B as necessary to obtain a satisfactory efficiency level of air conditioning system 610, 652. When the monitoring data center determines that an acceptable efficiency level has been reached, the method 1400B proceeds to step 1408B. At step 1408B, the recharge operation is completed. In some embodiments, the monitoring data center can generate an output indicative of the completed recharge operation and can indicate, for example, the amount of refrigerant added, the remaining refrigerant in a charging reservoir, the rate of loss of refrigerant over time, and/or any other suitable data. The data received and/or calculated by the monitoring data center can be provided to a remote server for storage, comparison, collation, and/or any other suitable use

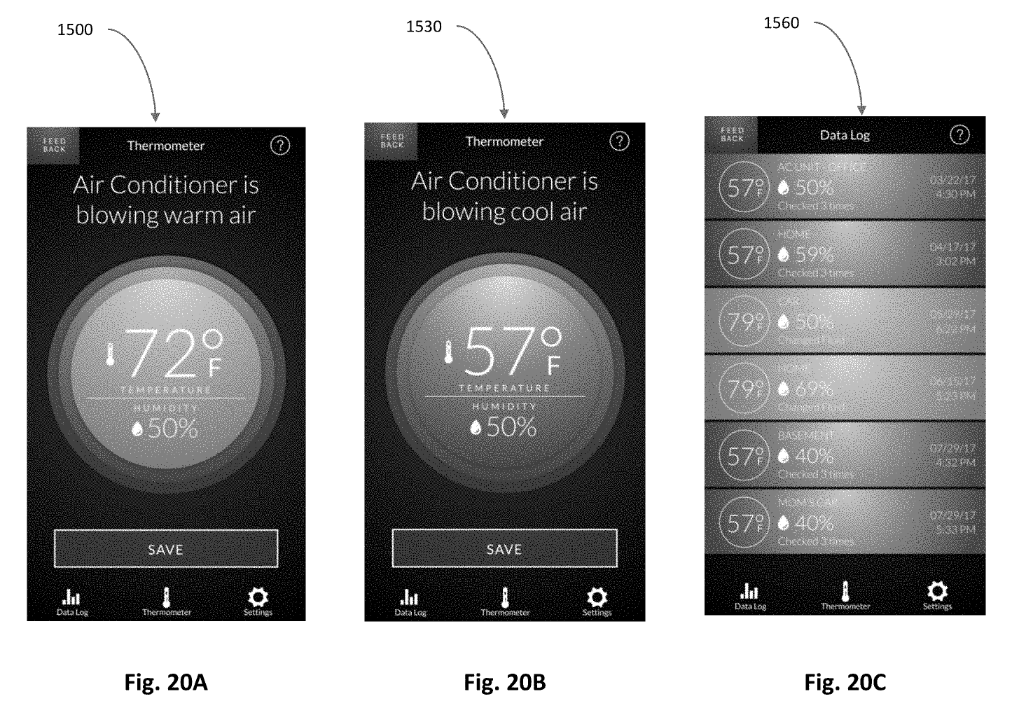

FIG. 20 illustrates a different user interface screen that can be generated and/or presented by the computing device 6 to monitor an air conditioning system. The user interface in FIG. 20 is different from the user interface illustrated in FIG. 8. The user interface illustrated in FIG. 8 uses the vent sensor to record outside ambient environmental information and helps the user to restore a satisfactory efficiency level of air conditioning unit by adjusting the level of refrigerant. In some embodiments, a low level of refrigerant prevents the air conditioning system from reaching an acceptable operating temperature. Adding refrigerant makes the air conditioning system work at a satisfactory efficiency level. The user interface illustrated in FIG. 20 is mainly a thermometer that measures air flow temperature and determines if the air conditioning system is working at a satisfactory efficiency. When the user logs into the user interface illustrated in FIG. 20, for example, using a mobile app, the user interface asks the user to share some of the user's information, such as, for example, the user's position. Knowing the user's position helps the user interface to determine the ambient environmental information, e.g., temperature and humidity, around the air conditioning system. In some embodiments, the user interface downloads the ambient environmental information from the Weather Channel web site. As discussed above, the user interface/computing device can utilize one or more algorithms, parameters, and/or other functions. The ambient environmental information is calculated and used in the backend of the user interface. After determining the difference between the optimal operating temperature and the current operating temperature, the user interface/computing device 6 can communicate and display the result. FIG. 20A shows the values of air flow parameters, for example, temperature and humidity, of the air conditioning system measured by the vent sensor. The mobile app communicates to the user the information that the air conditioning system is blowing warm air. FIG. 20B shows the same values of air flow parameters, temperature and humidity, of the air conditioning system measured by the vent sensor. Now the mobile app communicates to the user that the air conditioner is blowing cool air. Alternative and/or additional kinds of messages, for example, the air conditioning system is working properly, or the air conditioning system is working at a satisfactory efficiency, can be generated. FIG. 20C shows the history of every air conditioning system check. In other words, FIG. 20C shows the time and location of each air conditioning system check, for example, home, bedroom, living room, car, truck, etc.

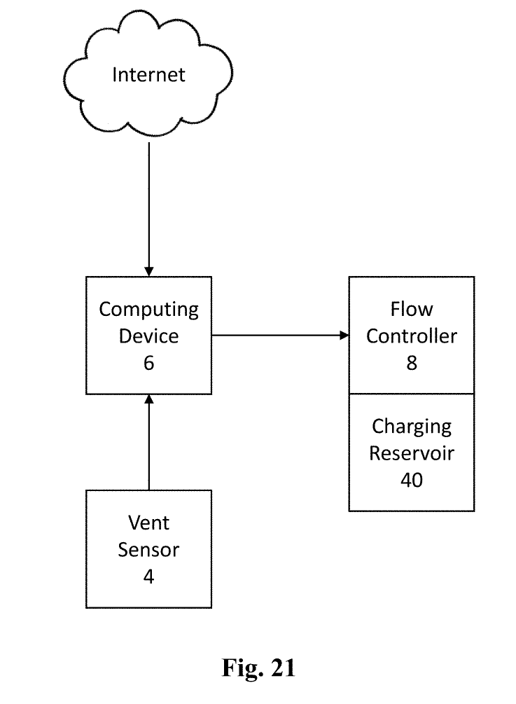

FIG. 21 illustrates a system for monitoring and performing a recharge operation of an air conditioning system. The system is similar to the system 2 discussed above in FIGS. 1, and similar description is not repeated. The system includes at least one vent sensor 4, a computing device 6, a flow controller 8, and a charging reservoir 40. The computing device 6 can be configured to receive and/or transmit data from the Internet using any suitable communication protocol and/or medium, such as GSM, 2G, 3G, 4G, LTE, Bluetooth, WiFi, Near-Field Communication (NFC), TCP/IP, Ethernet, IEEE 802.15.4 (LR-PANs), ZigBee, Thread, Zwave, IEEE 802.11ad (WiGig), Wi-Fi HaLow, IEEE 802.11p, 6LoWPAN, LP-WAN, LoRA, LoRaWAN, SigFox, Wi-SUN, Ingenu, DASH-7, Weightless, etc. For example, in some embodiments, the computing device 6 can be configured to download the parameters of the ambient environment around the air conditioning system, such as ambient temperature, ambient humidity, etc., from an Internet source, like the Weather Channel web site or other suitable source.

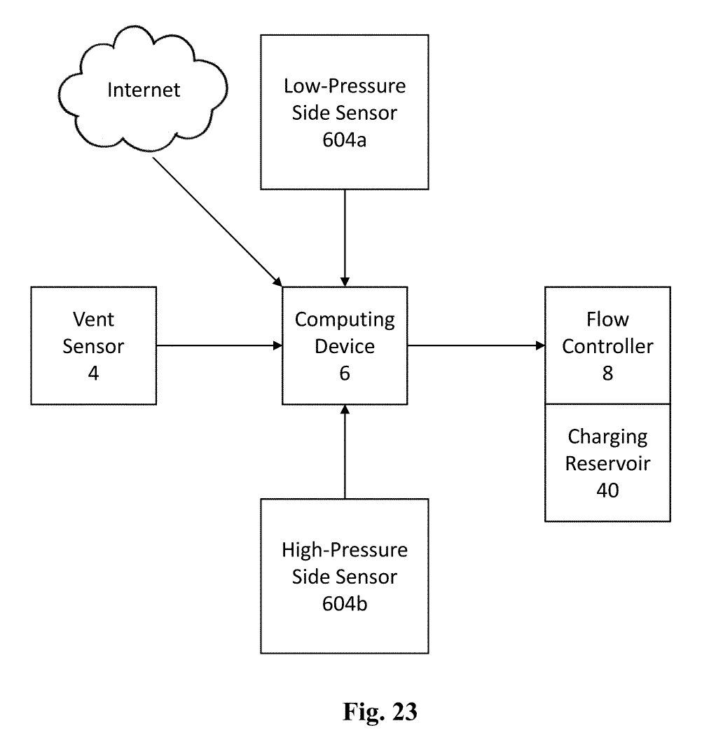

FIG. 23 illustrates a system for monitoring and performing a recharge operation of an air conditioning system. The system is similar to the system discussed above FIG. 21, system 602 discussed above FIG. 12, and similar description is not repeated. The system includes at least one vent sensor 4, a computing device 6, a flow controller 8, a charging reservoir 40, a first pressure sensor 604a, and a second pressure sensor 604b. All sensors are in signal communication with the computing device 6. All parameters (e.g., air flow and pressure parameters) are monitoring at the same time. The computing device 6 is configured to receive the signal from each sensor and perform one or more operations. In some embodiments, one or more computing devices 6 can be configured to receive the signal from the sensors. In some embodiments, the computing device is configured to calculate and monitor the operating parameters of the air conditioning system based on the one or more measured parameters and can be further configured to determine if the air conditioning system is working at a satisfactory efficiency. For example, in some embodiments, the one or more measured parameters include temperature of the output air flow and the fluid flow pressure. In such embodiments, the computing device 6 is configured to calculate the current level of efficiency of the air conditioning system based on measured parameters. The computing device 6 can be configured to determine whether the efficiency of the air conditioning system is too low, too high, or at an acceptable level based on the measured parameters, such as, for example, air flow temperature and low-pressure side pressure, and can be further configured to adjust the refrigerant charge level of air conditioning system in order to maintain a satisfactory efficiency.

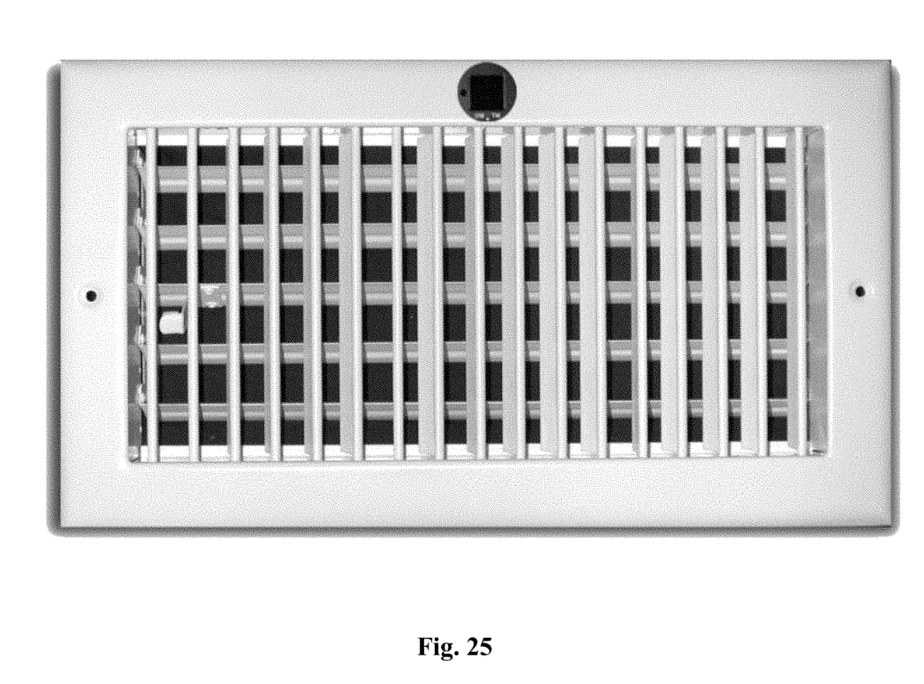

FIG. 25 illustrate a system for monitoring air flow of air conditioning system. The system includes a typical air conditioning vent/diffuser/register and a vent sensor. The sensor is similar to the vent sensor 4 and is able to record different air flow parameters, but, instead of being removably coupled to the vent, the sensor is integrated into the vent chassis. In some embodiments, the sensor has a sensing probe positioned inside the duct. In some embodiments, the sensor could be powered by a solar power module instead of a regular coin battery. The illustration represents just one type of air vent/register/diffuser. The idea is that all kinds of air vent/register/diffuser can be provided with a vent sensor, maybe in a different position but with the same functionality.

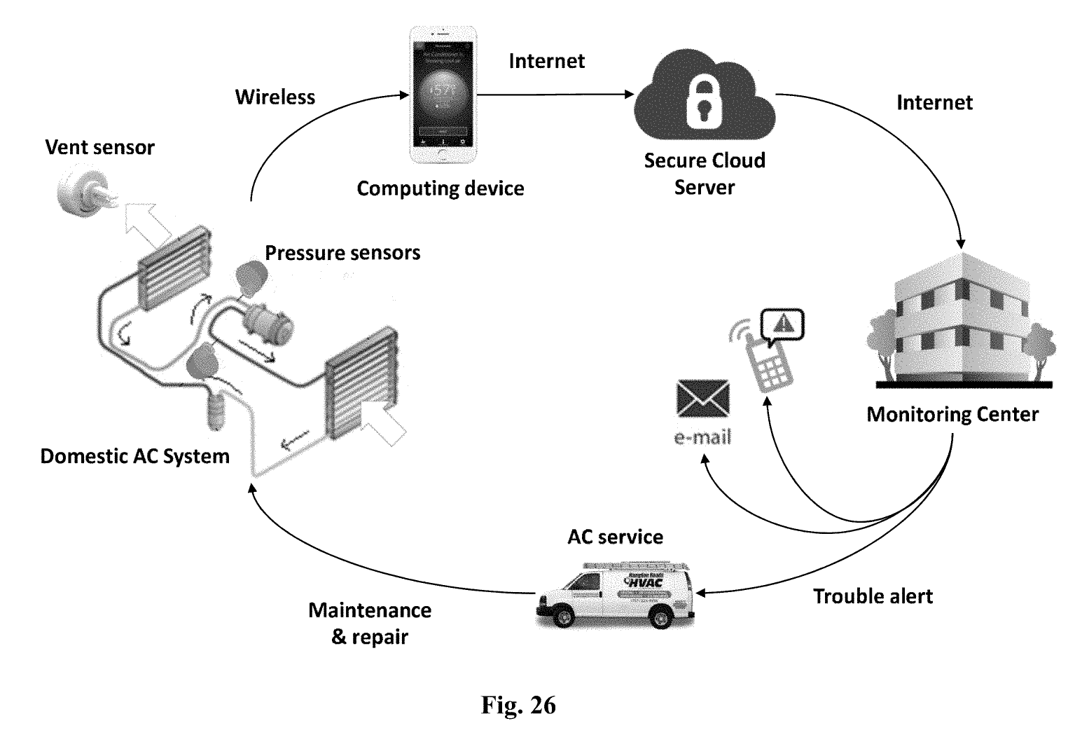

FIG. 26 illustrates a system for monitoring and preventing air conditioning system trouble. FIG. 26 represents a preventive maintenance service workflow diagram. The system includes at least one vent sensor 4, at least one pressure sensor, a computing device 6, a flow controller 8, a charging reservoir 40, a secure cloud server, a monitoring data center, and an AC service. The air conditioning system illustrated in FIG. 26 is a building air conditioning system, similar to the system explained in FIG. 11, for example, home, office building, condo, restaurant, hospital, school, etc. The system includes at least one vent sensor and at least one pressure sensor, or all different combinations according to FIG. 23. The sensors, and eventually the flow controller, are in communication with the computing device 6. Through the computing device, e.g., the user interface of FIG. 20, for example, a mobile app, the user can monitor the air flow parameters and pressure of the air conditioning system. Once the computing device has received the data from the sensors, the computing device is able to perform some operations, such as, for example, determining if the air conditioning system is working at a satisfactory efficiency. In addition, the computing device can be further configured to adjust the refrigerant charge level of air conditioning system in order to maintain a satisfactory efficiency. In some embodiments, the flow controller 8 and a charging reservoir, for example, a tank of refrigerant, can be connected to the air conditioning system. Usually this happens when the AC service wants to perform a recharging operation. The AC service connects the tank of refrigerant, re-charges the system, and removes the tank. In some embodiments, a flow controller and a charging reservoir could be permanently connected to the air conditioning system. If the computing device 6 determines that the air conditioning system is operating at a low level of efficiency, then the monitoring data center could increase and/or decrease the refrigerant charge level of the air conditioning system to an acceptable level in order to maintain a satisfactory efficiency. In some embodiments, the computing device is configured to send and receive data to/from the monitoring center. In some embodiments, the monitoring data center generates at least one message/indication to the user about the conditions of air conditioning system, for example a pop up notification, a Facebook notification, an email, a text, etc. Once detected the issue, the monitoring center is configured to alert and direct the closest AC service to the air conditioning system in order to fix the issue.

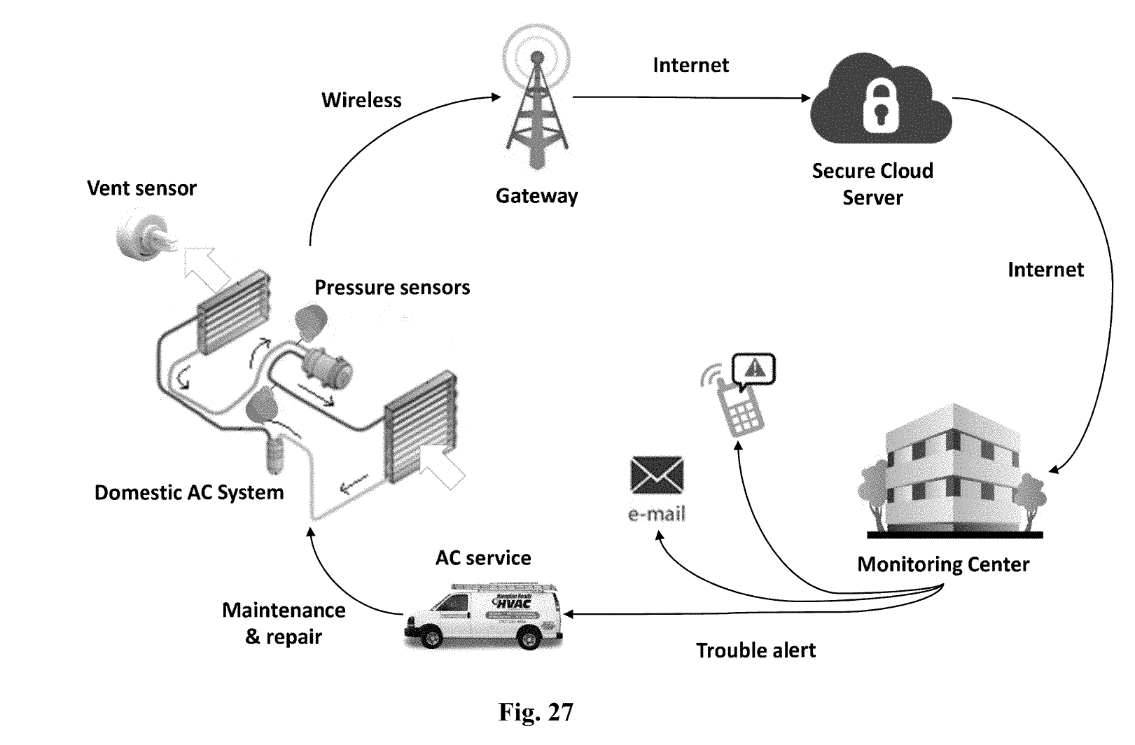

FIG. 27 illustrates a system for monitoring and preventing air conditioning system trouble. FIG. 27 represents a preventive maintenance service workflow diagram. The system is similar to the system discussed above FIG. 26 and similar description is not repeated. The system includes at least one vent sensor 4, at least one pressure sensor, a flow controller 8, a charging reservoir 40, a gateway, a secure cloud server, a monitoring data center, and an AC service. The main difference between the systems in FIGS. 26 and 27 is that the system in FIG. 27 can monitoring the air conditioning system any time, 24/7, in real time. In some embodiments, the gateway can be represented by a tower, a strand, or a wireless router, such as, for example, a Comcast WiFi router. All the sensors and the flow controller are in communication with the monitoring center through the gateway. It means that it is not necessary to use a computing device, for example, a cell phone, connected to the sensors and/or the flow controller in order to monitor the air conditioning system. This solution solves the problem of monitoring the air conditioning system when the user is at work, or he is not close to the air conditioning system.

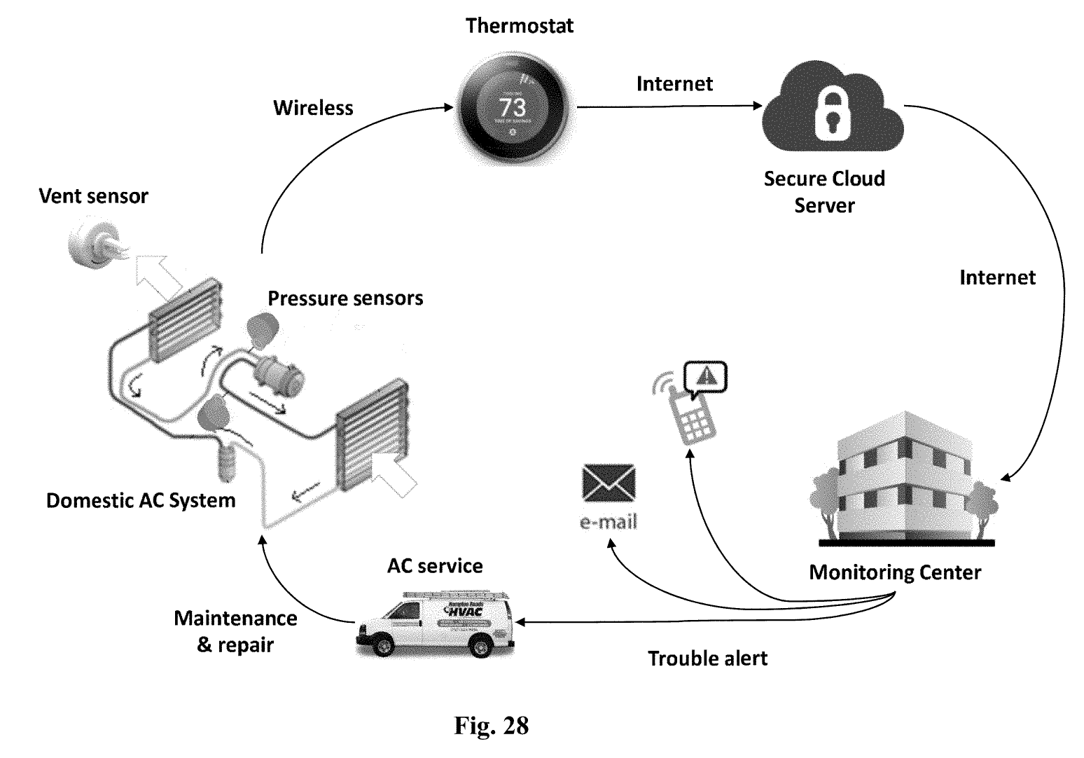

FIG. 28 illustrates a system for monitoring and preventing air conditioning system trouble. FIG. 28 represents a preventive maintenance service workflow diagram. The system is similar to the system discussed above in FIG. 26 and similar description is not repeated. The system includes at least one vent sensor 4, at least one pressure sensor, a home thermostat, a flow controller 8, a charging reservoir 40, a secure cloud server, a monitoring data center, and an AC service. All the sensors and/or the flow controller can be in communication by wire or wirelessly. In some embodiments, the computing device 6 can be a thermostat and/or a temperature controller, such as, for example, a home thermostat. In some embodiments, the computing device 6, such as, for example, a home thermostat, can be configured to perform certain operations. In some embodiments, the home thermostat can be configured to transmit the information to the monitoring center.

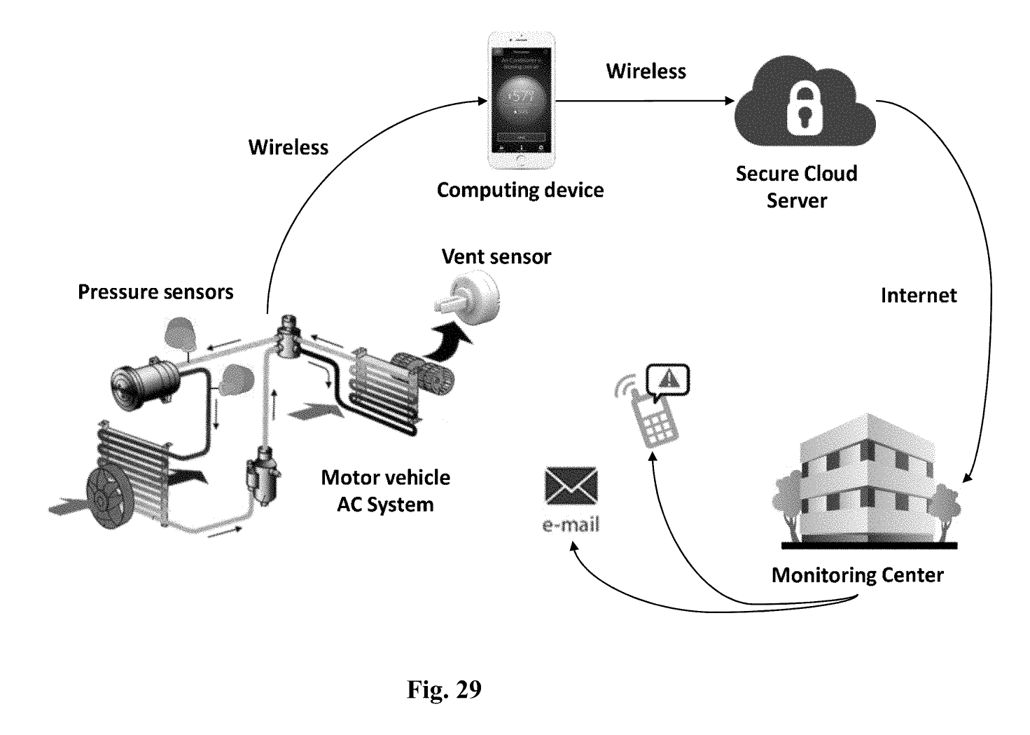

FIG. 29 illustrates a system for monitoring and preventing air conditioning system trouble. FIG. 29 represent a preventive maintenance service workflow diagram. The system includes at least one vent sensor 4, at least one pressure sensor, a computing device 6, a flow controller 8, a charging reservoir 40, a secure cloud server, and a monitoring data center. The system is similar to the system discussed above in FIG. 26 and same description is not repeated. The air conditioning system illustrated in FIG. 29 is a motor vehicle air conditioning system, similar to the system explained in FIG. 10. The system represented an independent air conditioning monitoring system. The user could buy the sensors (e.g., vent and pressure sensors) and install the air conditioning monitoring system in his car. The user will be able to monitor his car AC system using a computing device, such as, for example, a cell phone.

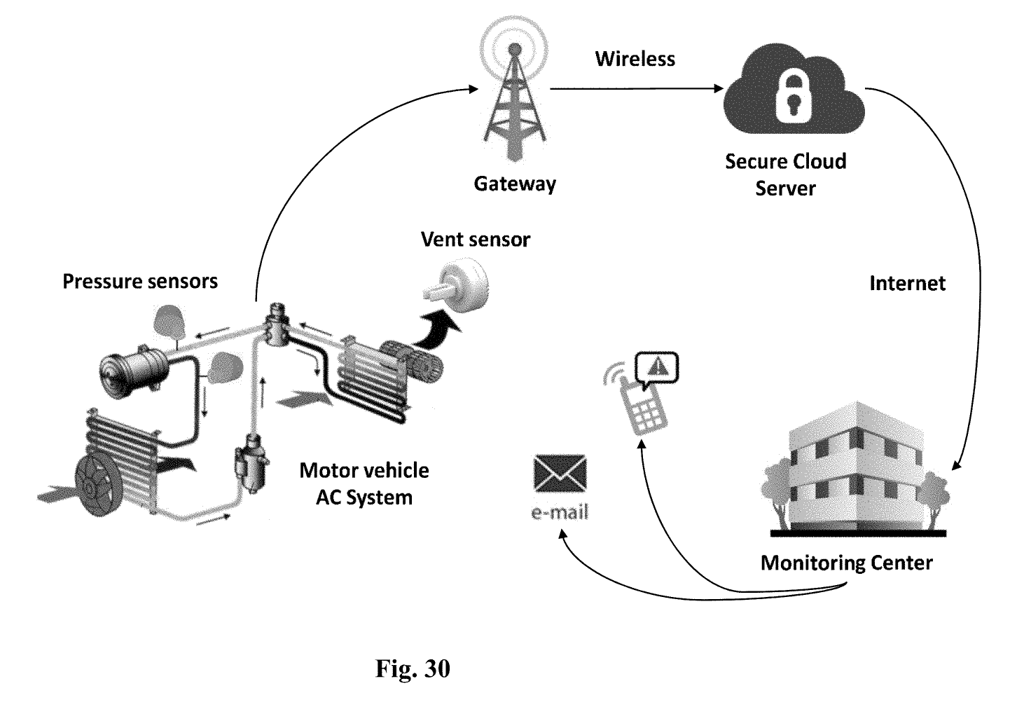

FIG. 30 illustrates a system for monitoring and preventing air conditioning system trouble. FIG. 30 represent a preventive maintenance service workflow diagram. The system is similar to the system discussed above in FIG. 27 and FIG. 29 and same description is not repeated. This solution solves the problem of monitoring the air conditioning system when the motor vehicle, for example, parking, and the user, and his cell phone, is not close to the air conditioning system.

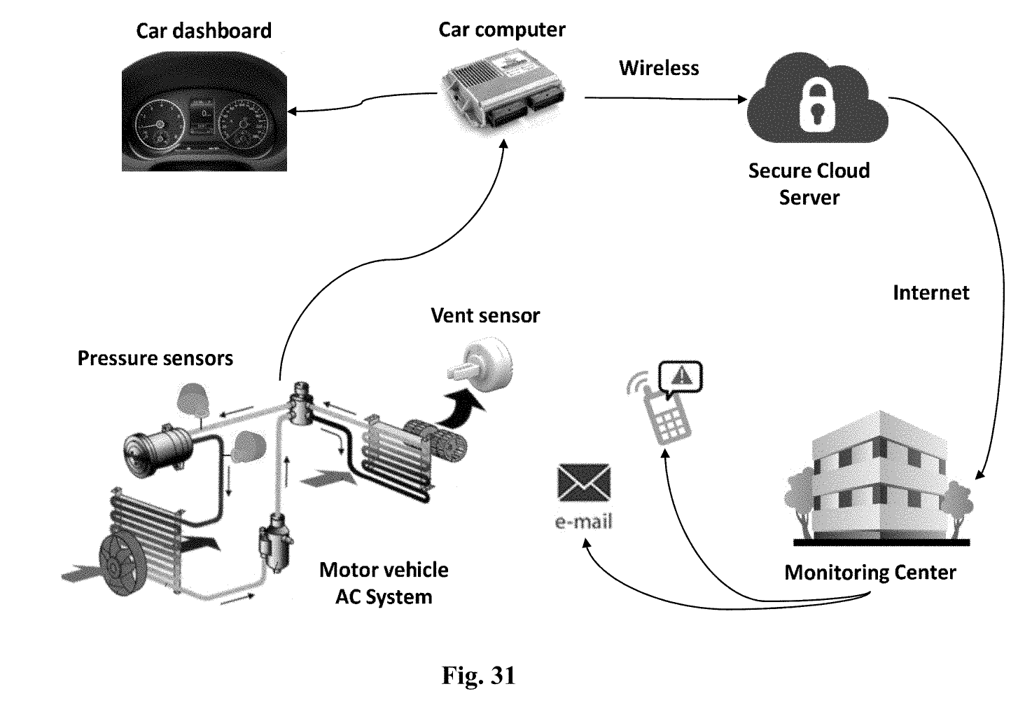

FIG. 31 illustrates a system for monitoring and preventing air conditioning system trouble. FIG. 31 represent a preventive maintenance service workflow diagram. The system is similar to the system discussed above in FIG. 29 and same description is not repeated. The system includes at least one vent sensor 4, at least one pressure sensor, a car computer, a car dashboard, a flow controller 8, a charging reservoir 40, a secure cloud server, and a monitoring data center. All the sensors can be in communication by wire or wirelessly. The car computer will perform the same operations performed by the computing device and it will display the result through the car dashboard. In some embodiments, the car computer can be configured to transmit the information to the monitoring center.

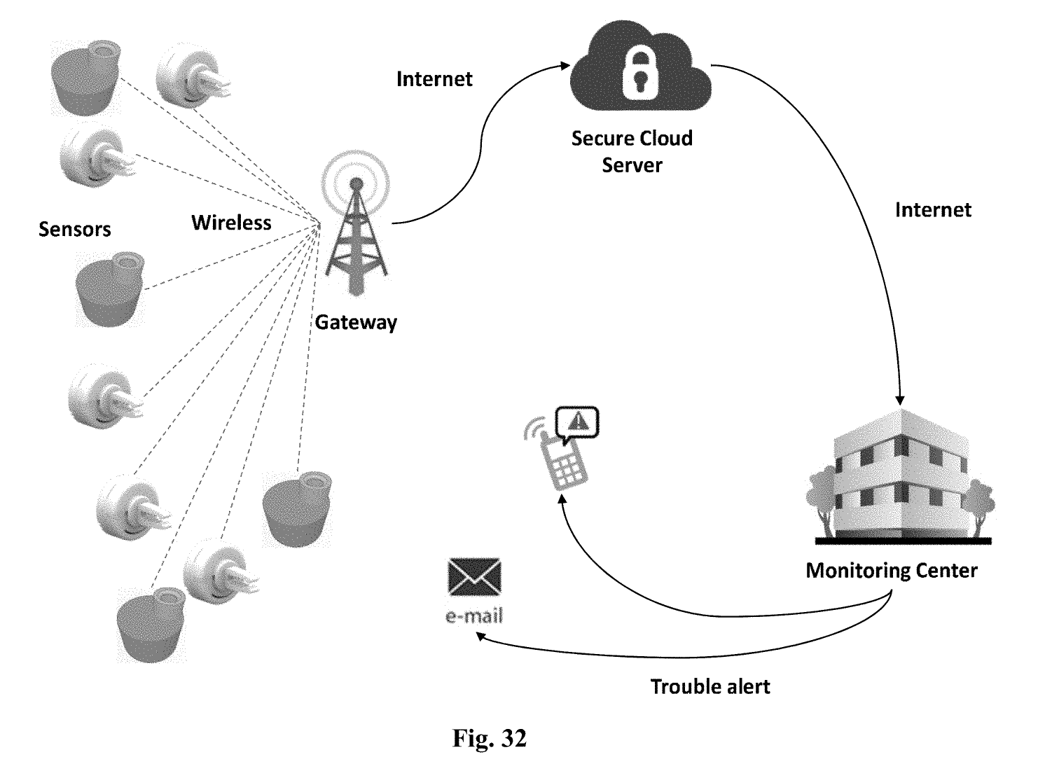

FIG. 32 illustrates a smart city network. All the sensors, for example, IoT (Internet of thing) sensors, that monitor different air conditioning systems, are in signal communication with a gateway, for example, a tower or a consumer router. All the data collected by the sensors, such as, for example, vent sensor or pressure sensor, are transmitted through a secure cloud server to the monitoring data center. The monitoring center is configured to perform some operations, for example, determining if the air conditioning system is working at a satisfactory efficiency. In some embodiments, the monitoring data center is configured to send a message/warning to a mobile device, such as, for example, cell phone, as a text message, or email, or social media message, etc. In some embodiment, the monitoring data center is configured to alert different functions, such as, for example, a service maintenance.

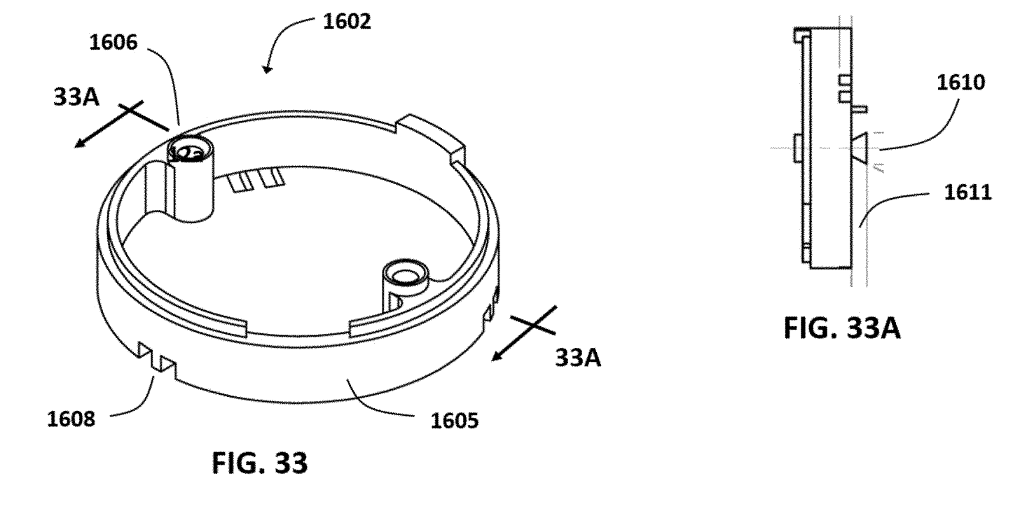

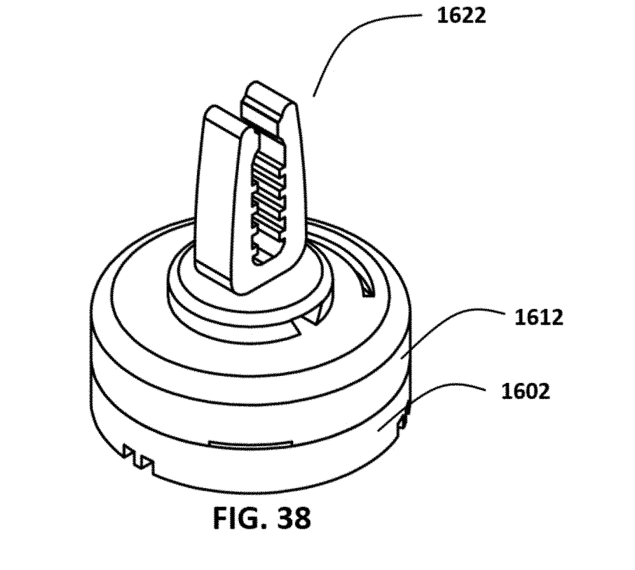

FIG. 33 illustrates different views of a bottom case 1602 of the vent sensor 1604 of FIGS. 38- 40, according to one embodiment. The bottom case 1602 includes a cylindrical body 1605 with two post holes 1606. The cylindrical body 1605 includes three pairs of exhaust openings 1608 and a male dovetail feature 1610 on the rear face 1611. The exhaust openings 1608 allow the air flow to exit the body.

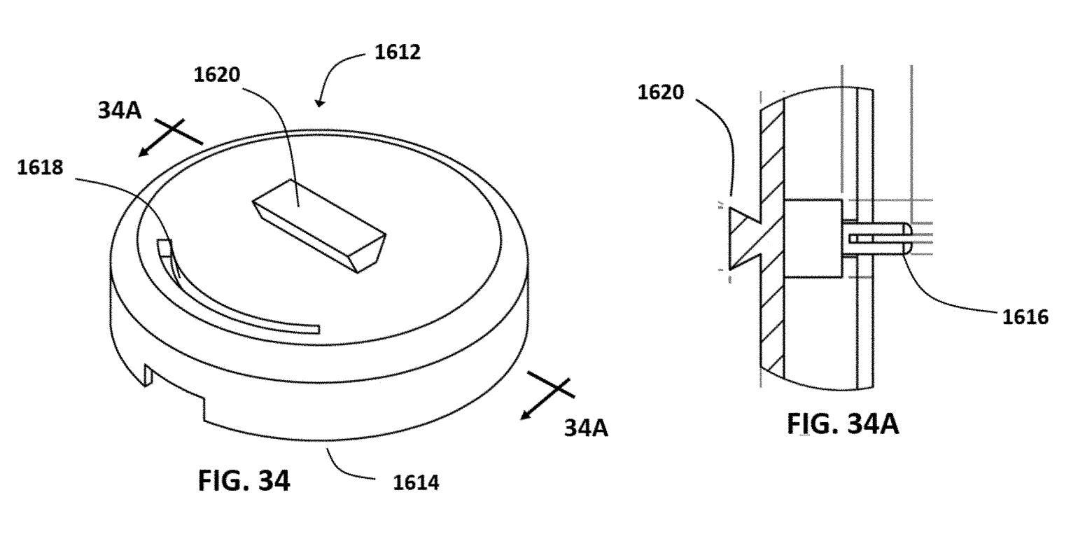

FIG. 34 illustrates different views of a top case 1612 of the vent sensor 1604 of FIGS. 38-40. The top case 1612 includes a cylindrical body 1614 with two pins 1616 that engage the two post holes 1606 of the bottom case 1602 of FIG. 33 to form the engagement mechanism that keeps the top case 1612 engaged with the bottom case 1602. The cylindrical body 1614 includes one curved intake opening 1618 and a male dovetail feature 1620 on the front face 1621 that is similar to the male dovetail feature 1610 on the rear face 1611 of the bottom case 1602. The intake allows the air flow to enter the body and reach the sensor board (not shown), which is mounted within the vent body 1615 formed by the engaged bottom and top cases, 1602 and 1612. In one implementation, the sensor board is a Bluetooth temperature and humidity sensor from Chongqing Jinou Science and Technology Development Co., Ltd of China that can sense air temperature and humidity and wirelessly transmit temperature and humidity data to a remote receiver.

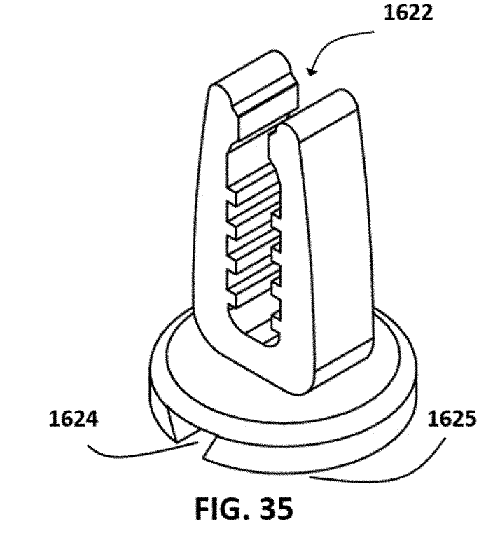

FIG. 35 illustrates a clip mount 1622 for the vent sensor 1604 of FIG. 38. The clip mount 1622 includes a female dovetail feature 1624 on the bottom face 1625 that is designed to receive a corresponding male dovetail feature, such as the male dovetail feature 1610 of the bottom case 1602 of FIG. 33, as illustrated at the bottom of FIG. 38, or the male dovetail feature 1620 of the top case 1612 of FIG. 34, as illustrated at the top of FIG. 38. The clip mount 1622 is sized and configured to couple the vent sensor 1604 to the front or back side of an output air vent of an air conditioning system. When coupled to the front side of an output air vent (i.e., the downstream side), the clip mount 1622 should be coupled to top case 1612 of the vent sensor 1604 to ensure that the air flow enters through the top case 1612 and exits through the bottom case 1602. Alternatively, when coupled to the back side of an output air vent (i.e., the upstream side), the clip mount 1622 should be coupled to bottom case 1602 of the vent sensor 1604 to ensure that the air flow enters through the top case 1612 and exits through the bottom case 1602.

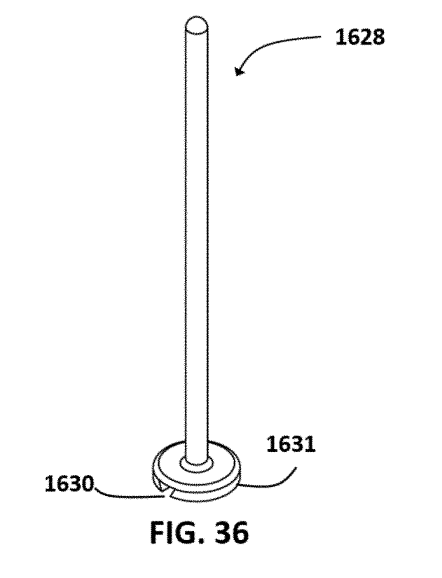

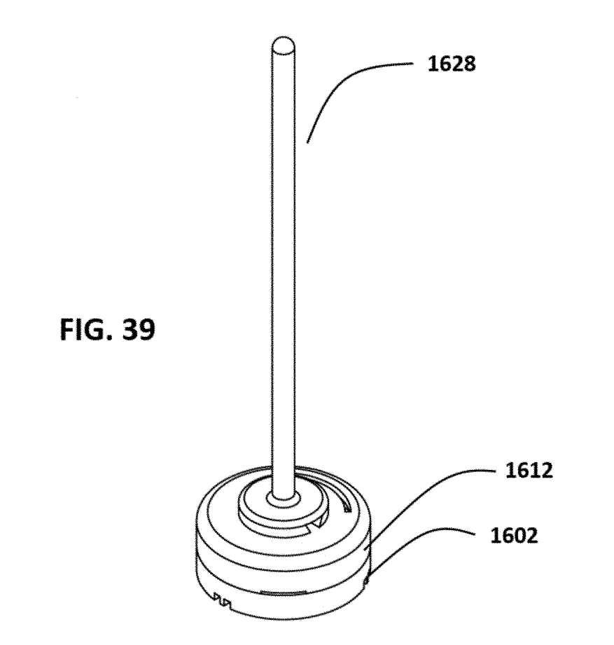

FIG. 36 illustrates a pin mount 1628 for the vent sensor 1604 of FIG. 39. The pin mount includes a female dovetail feature 1630 on the bottom face 1631 that is designed to receive the male dovetail feature on either the bottom case 1602 of FIG. 33 or the top case 1612 of FIG. 34.

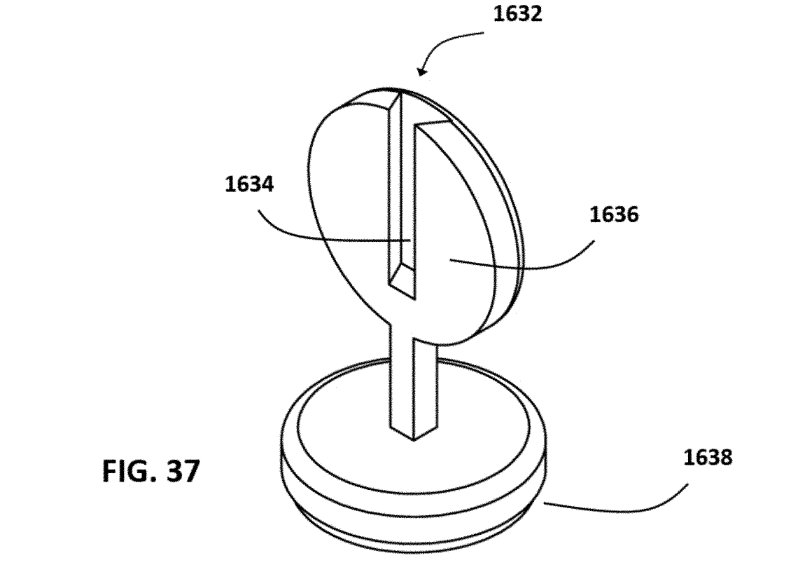

FIG. 37 illustrates an adhesive mount 1632 for the vent sensor 1604 of FIG. 40. The adhesive mount 1632 includes a female dovetail feature 1634 on the bottom face 1636 and an attachment mechanism 1638. The female dovetail feature 1634 is designed to receive the male dovetail feature on either the bottom case 1602 of FIG. 33 or the top case 1612 of FIG. 34. The attachment mechanism 1638 is designed to receive an adhesive, for example, a two-sided adhesive tape, on the external surface.

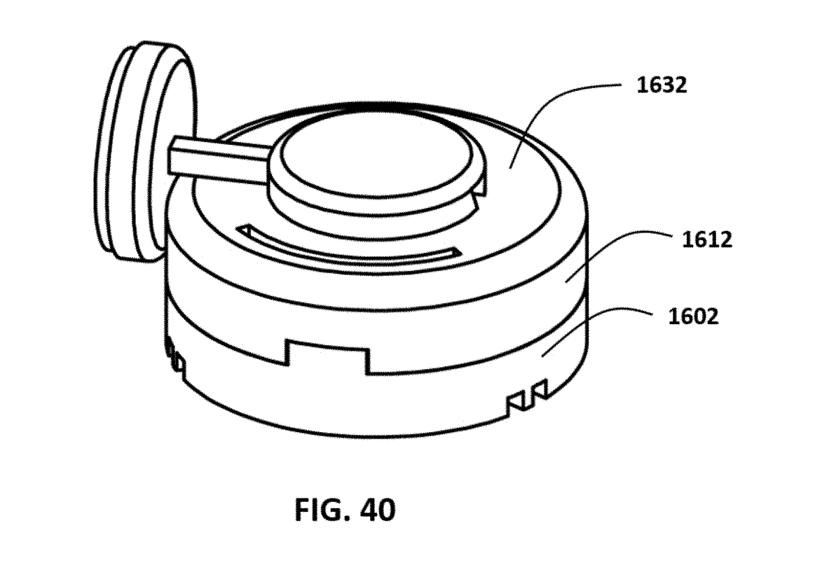

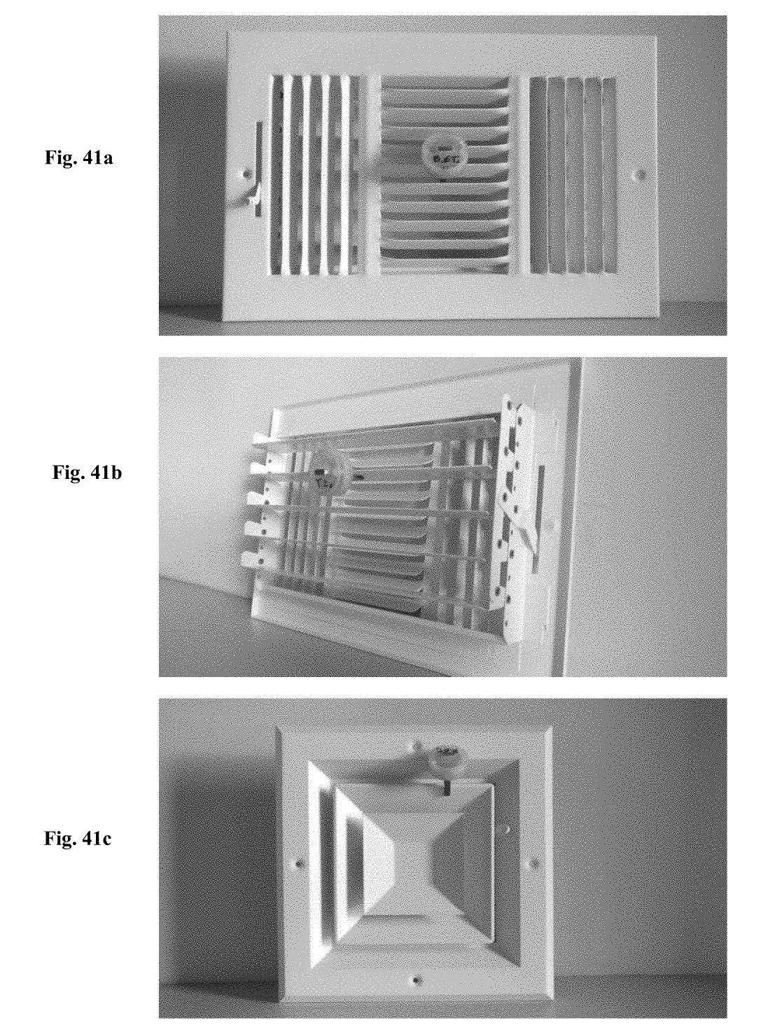

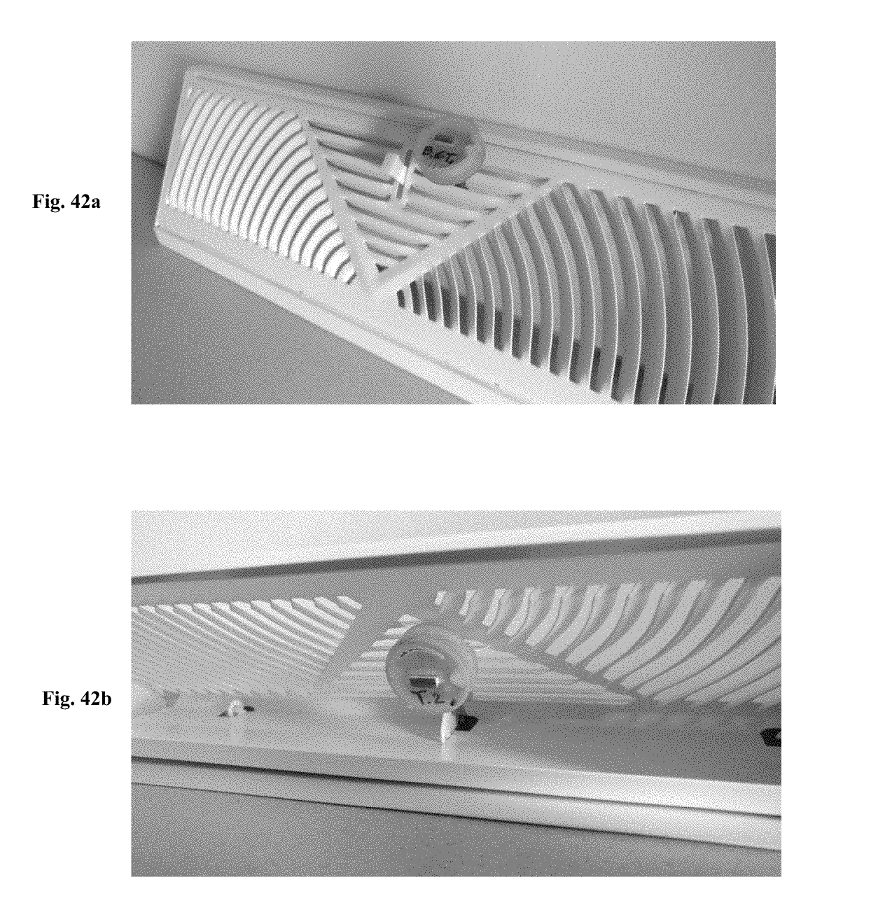

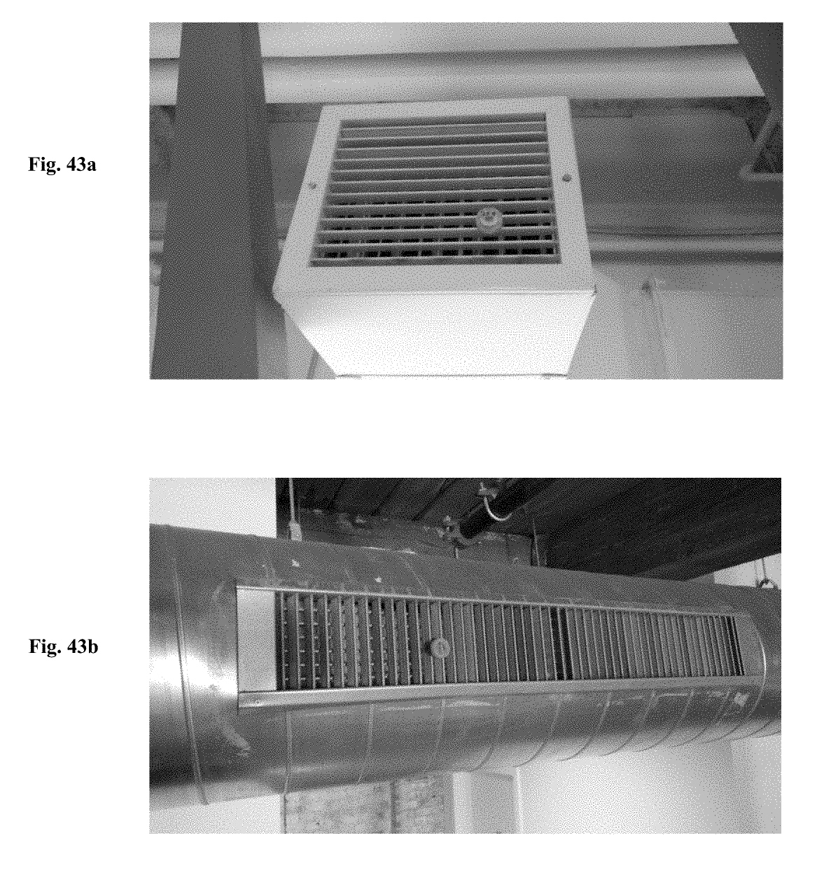

FIG. 38 illustrates a vent sensor 1604 with the clip mount 1622 of FIG. 35 alternatively mounted to the top case 1612 of FIG. 34 (figures at the top of FIG. 38) and to the bottom case 1602 of FIG. 33 (figures at the bottom of FIG. 38). FIGS. 41a, 41b, 41c, 42a, 42b, and 43a and 43b illustrate some examples of clip mount installations.

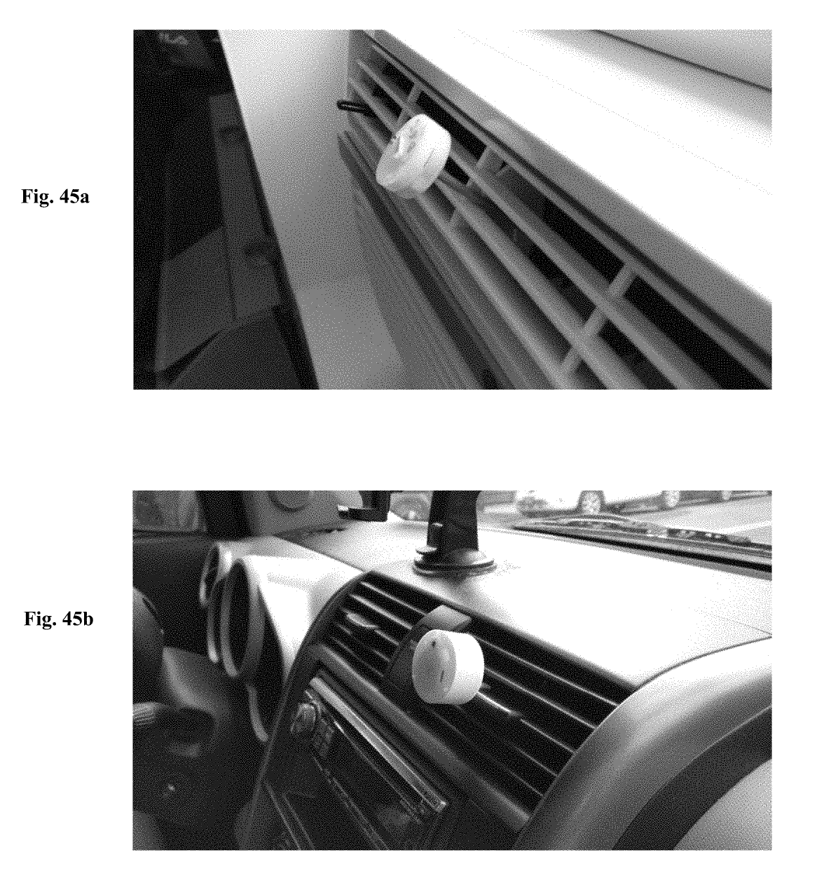

FIG. 39 illustrates the vent sensor 1604 with the pin mount 1628 of FIG. 36 mounted to the top case 1612 of FIG. 34. The vent sensor assembly of FIG. 39 can be used to monitor a vehicle air conditioning system by inserting the long pin into the front of an output air vent with the vent sensor abutting the front side of the air vent. FIGS. 45a and 45b illustrate two examples of pin mount installations.

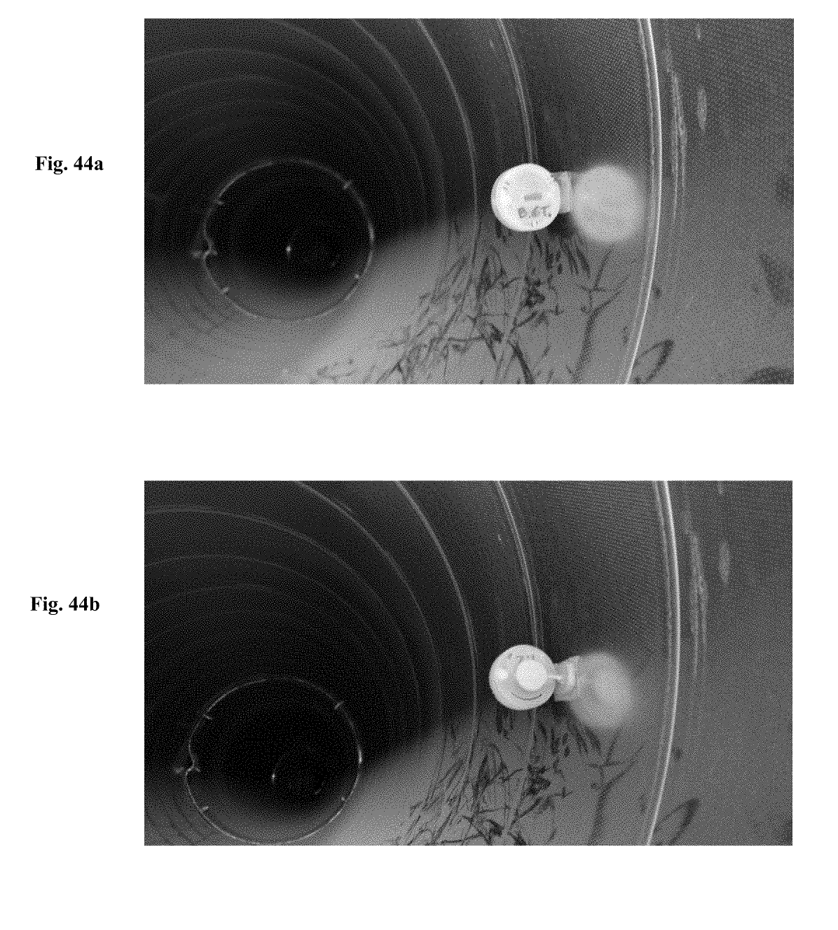

FIG. 40 illustrates the vent sensor 1604 with the adhesive mount 1632 of FIG. 37 alternatively mounted to the top 1612 case of FIG. 34 and to the bottom case 1602 of FIG. 33. The assemblies of FIG. 40 can be used to mount the vent sensor within a duct of an air conditioning system with the adhesive bonding the assembly to the side wall of the duct with the assembly properly oriented to ensure that the air flow enters through the front case and exits through the bottom case 1602. FIGS. 44a and 44b illustrate two examples of clip mount installations.

What is claimed is:

1. A monitoring system, for controlling a refrigerant within an air conditioning system, said monitoring system comprising:
a first sensor measuring air temperature of at least one output vent of said air conditioning system;
a second sensor measuring at least one environmental parameter;
at least one pressure sensor measuring an operating pressure of said refrigerant within said air conditioning system;
a computer device in signal communication with said first, second, and pressure sensors, said computer device configured to receive signals indicative of said air temperature, said operating pressure, and said at least one environmental parameter from said sensors;
a pressurized refrigerant reservoir for supplying refrigerant to said air conditioning system;
a flow controller for controlling refrigerant within said air conditioning system, said flow controller providing fluid communication between said pressurized refrigerant reservoir and said air conditioning system; wherein
said flow controller is in signal communication with said computer device, said flow controller being configured to receive signals from said computer device.

2. The monitoring system according to claim 1, wherein:
said first sensor is configured to send a first signal indicative of said air temperature of at least one output vent of said air conditioning system to said computer device;
said second sensor is configured to send a second signal indicative of said at least one environmental parameter to said computer device;
said at least one pressure sensor is configured to send a third signal indicative of said operating pressure of said refrigerant to said computer device;
said computer device is configured to generate a signal indicative of adding refrigerant to said air conditioning system in response to receiving said first, second, and third signals; and
said flow controller is configured to add refrigerant upon receipt of said signal indicative of adding refrigerant.

3. The monitoring system according to claim 2, wherein said signal indicative of adding refrigerant is generated when said operating pressure is less than a threshold pressure range, said signal indicative of adding refrigerant is determined by said computer device with reference to a refrigerant performance table stored in said computer device, said refrigerant performance table relating said threshold pressure range to said air temperature of said at least one output vent and said environmental parameter.

4. The monitoring system according to claim 3, wherein said refrigerant performance table is provided in FIG. 6A.

5. The monitoring system according to claim 1, wherein said flow controller is in fluid communication with a low pressure side of said air conditioning system.

6. The monitoring system according to claim 1 wherein said operating pressure is measured at said low pressure side of said air conditioning system.

7. The monitoring system according to claim 1, wherein said operating pressure is measured at a high pressure side of said air conditioning system.

8. The monitoring system according to claim 1, further comprising a second pressure sensor for measuring said operating pressure at said high pressure side of said air conditioning system, wherein said operating pressure is measured at both said low pressure and said high pressure side of said air conditioning system.

9. The monitoring system according to claim 1, wherein said at least one environmental parameter comprises ambient temperature.

10. The monitoring system according to claim 1, wherein said at least one environmental parameter comprises ambient humidity.

11. The monitoring system according to claim 1, further comprising a plurality of vent sensors, located in respective output vents of said air conditioning system.

12. The monitoring system according to claim 1, wherein said computer device is a remote server.

13. The monitoring system according to claim 1, wherein said signals are communicated wirelessly.

14. A process for controlling refrigerant pressure within an air conditioning system, said process comprising:
measuring air temperature of at least one output vent of said system;
measuring an operating pressure of a refrigerant within said system;
measuring at least one environmental parameter;
determining, using said air temperature and said environmental parameter, a threshold pressure range of said refrigerant;
comparing said operating pressure with said threshold pressure range of said refrigerant; and
adding refrigerant to said system when said operating pressure is less than said threshold pressure range.

15. The process according to claim 14 further comprising:
sending a first signal indicative of said air temperature of said at least one output vent of said system to a computer device;
sending a second signal indicative of said operating pressure of said refrigerant to said computer device;
sending a third signal indicative of said environmental parameter to said computer device;
receiving by said computer device said first, second and third signals;
said computer device using said air temperature and said environmental parameter, to determine a threshold pressure range of said refrigerant;
using said computer device to compare said operating pressure and said threshold pressure range of said refrigerant; and
using said computer device to generate a signal to a flow controller for adding said refrigerant when said operating pressure is below said threshold pressure range.

16. The process according to claim 15, wherein determining said threshold pressure range comprises:
using a refrigerant performance table stored in said computer device, said refrigerator performance table relating said threshold pressure range to said air temperature and said environmental parameter.

17. The process according to claim 16, wherein said refrigerator performance table is provided in FIG. 6A.

18. The process according to claim 14, wherein said flow controller adds refrigerant to a low pressure side of said system.

19. The process according to claim 14 wherein said operating pressure is measured at said low pressure side of said system.

20. The process according to claim 14 wherein said operating pressure is measured at a high pressure side of said system.

21. The process according to claim 14, further comprising measuring a second operating pressure of said system, wherein said operating pressure is measured at both said low pressure side and said said high pressure side of said system.

22. The process according to claim 14, wherein said at least one environmental parameter that is measured is ambient temperature.

23. The process according to claim 14, wherein said at least one environmental parameter that is measured is ambient humidity.

24. The process according to claim 14, wherein said signals are communicated wirelessly.

25. The process according to claim 15, wherein said computer device is a remote server.

26. A pressure sensor comprising:
a body defining an inlet;
a pressure sensor unit positioned within said body, said pressure sensor unit in fluid communication with an air conditioning system refrigerant, said pressure sensor unit measures an operating pressure of said air conditioning system refrigerant.

27. The system according to claim 26, wherein said inlet comprises a seal configured to provide a fluid tight seal with an access valve of said air conditioning system.

28. The pressure sensor according to claim 26, further comprising a communication module in signal communication with said pressure sensor unit and a computer device, wherein said communication module is configured to transmit said operating pressure of said refrigerant to said computer device.

29. The pressure sensor according to claim 26, wherein said pressure sensor is coupled to a low pressure side of said air conditioning system.

30. The pressure sensor according to claim 26, wherein said pressure sensor is coupled to a high pressure side of said air conditioning system.
